(19) United States
(12) Patent Application Publication
(10) Pub. No.: US 2017/0041399 A1
(43) Pub. Date: Feb. 9, 2017

(54) COMMUNICATIONS MANAGEMENT SYSTEM, COMMUNICATIONS SYSTEM, NON-TRANSITORY RECORDING MEDIUM, AND COMMUNICATIONS MANAGEMENT METHOD

(71) Applicant: Atsushi KOKUBO, Kanagawa (JP)

(72) Inventor: Atsushi KOKUBO, Kanagawa (JP)

(21) Appl. No.: 15/223,872

(22) Filed: Jul. 29, 2016

(30) Foreign Application Priority Data
Aug. 4, 2015 (JP) 2015-154113

(51) Int. Cl. H04L 29/08

(52) U.S. Cl. CPC H04L 67/14

(57) ABSTRACT

A communications management system includes at least one processor configured to manage a session for carrying out transmission and reception of content data between a first communications terminal configured to control a predetermined apparatus, a second communications terminal, and a third communications terminal; and change a setting that a communications terminal allowed to operate the predetermined apparatus through communications with the first communications terminal is the second communications terminal to a setting that a communications terminal allowed to operate the predetermined apparatus through communications with the first communications terminal is the third communications terminal.

### CROSS-REFERENCE TO APPLICATIONS

The present patent application is based on and claims the benefit of priority of Japanese Priority Application No. 2015-154113, filed on Aug. 4, 2015, the entire contents of which are hereby incorporated herein by reference.

### BACKGROUND

1. Technical Field

The present disclosure relates to a communications management system, a communications system, a non-transitory recording medium, and a communications management method.

2. Description of the Related Art

For example, a video conference system in which, through a communications network such as the Internet or a LAN (Local Area Network), a video conference is carried out using a plurality of communications terminals between a plurality of places, has been wide spread.

Also, a technology with which, in a telepresence robot system that includes a plurality of remote stations and a plurality of robots movable through remote control, the remote stations control the robots, is known (for example, see Japanese Translation of PCT International Application Publication No. 2012-523890).

### SUMMARY

According to one aspect, a communications management system includes at least one processor configured to manage a session for carrying out transmission and reception of content data between a first communications terminal configured to control a predetermined apparatus, a second communications terminal, and a third communications terminal; and change a setting that a communications terminal allowed to operate the predetermined apparatus through communications with the first communications terminal is the second communications terminal to a setting that a communications terminal allowed to operate the predetermined apparatus through communications with the first communications terminal is the third communications terminal.

Other objects, features, and advantages will become more apparent from the following detailed description when read in conjunction with the accompanying drawings.

### BRIEF DESCRIPTION OF THE DRAWINGS

FIG. 1 illustrates a configuration example of a communications system according to embodiments;

FIG. 2 illustrates a hardware configuration example of a terminal according to the embodiments;

FIG. 3 illustrates a hardware configuration example of a management system and a relay apparatus according to the embodiments;

FIG. 4 illustrates a hardware configuration example of a moving apparatus according to the embodiments;

FIG. 5 illustrates a functional configuration example of the communications system according to a first embodiment;

FIGS. 6A-6C, 7A, and 7B illustrate an example of information managed by the management system according to the first embodiment;

FIG. 8 is a sequence diagram illustrating an example of a process in a preparation stage of the communications system according to the first embodiment;

FIG. 9 is a sequence diagram illustrating an example of a communications process of the communications system according to the first embodiment;

FIG. 10 illustrates an example of a display screen page of the terminal according to the first embodiment;

FIG. 11 is a sequence diagram illustrating an example of an apparatus operation authority transfer process according to the first embodiment;

FIG. 12 illustrates an example of a destination selection screen page of the terminal according to the first embodiment;

FIG. 13 is a sequence diagram illustrating an example of an apparatus operating process and an apparatus operation authority return process according to the first embodiment;

FIG. 14 illustrates an example of a display screen page of the terminal to which apparatus operation authority has been transferred according to the first embodiment;

FIG. 15 is a sequence diagram illustrating an example of a process to end communications according to the first embodiment;

FIG. 16 is a sequence diagram illustrating an example of an apparatus operation authority acquisition process according to the first embodiment;

FIG. 17 is a flowchart illustrating an example of a process to receive operation instruction information according to the first embodiment;

FIG. 18 illustrates a functional configuration example of a communications system according to a second embodiment; and

FIG. 19 is a sequence diagram illustrating an example of a process of operating an apparatus according to the second embodiment.

### DETAILED DESCRIPTION OF EMBODIMENTS

For example, in a communications system such as a video conference system using a communications terminal that can remotely control a predetermined apparatus (for example, a moving apparatus), a user who participates in a video conference may be not used to operating the predetermined apparatus. In such a case, upon using the predetermined apparatus, the user may, for example, ask a person in charge who is used to operating the predetermined apparatus to operate the predetermined apparatus.

However, in the related art, it may be difficult for a user to ask another user to operate a predetermined apparatus in a communications system that includes a communications terminal capable of controlling the predetermined apparatus.

Embodiments of the present invention have been devised in consideration of such a situation, and an object of the embodiments is to provide a communications management system with which it is possible to make it easier for a user to ask another user to operate a predetermined apparatus.

The embodiments of the present invention will now be descried with reference to the drawings. The embodiments which will now be described are merely examples, and embodiments of the present invention are not limited to these embodiments. Note that, in all the drawings for illustrating the embodiments, the same reference numerals are given to the elements that have the same functions, and duplicate description will be omitted.

### <System Configuration>

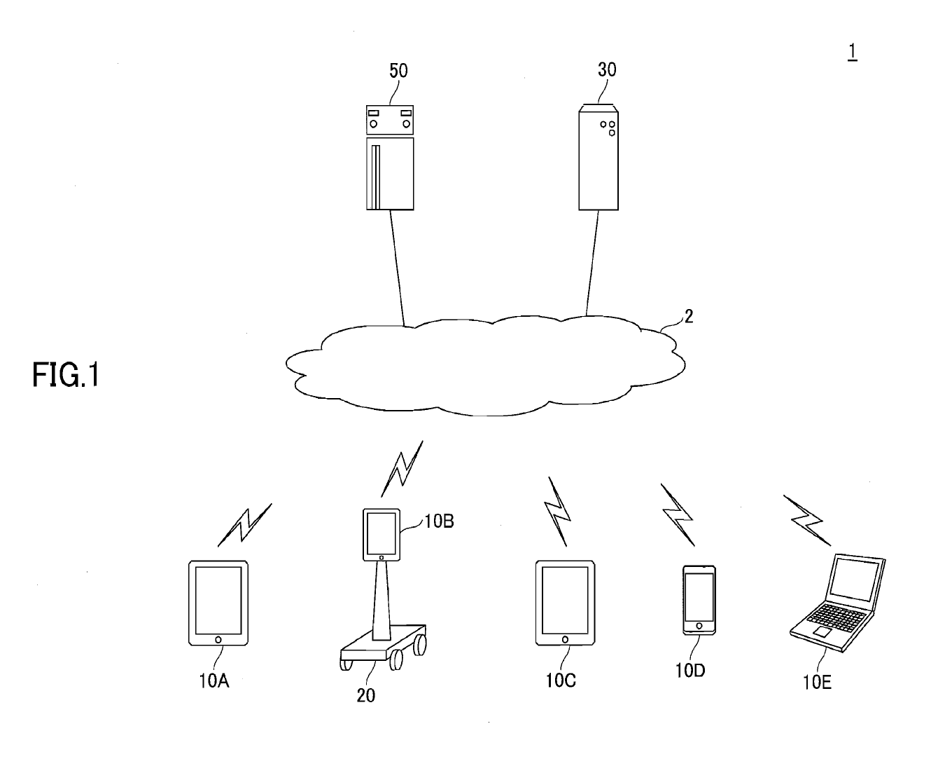

FIG. I illustrates a configuration example of a communications system according to the embodiments. The communications system 1 includes a plurality of terminals 10A, 10B, 10C, 10D, and 10E, a moving apparatus 20, a relay apparatus 30, and a management system 50. Below, any one of the terminals 10A, 10B, 10C, 10D, and 10E may be referred to as a “terminal 10”. The actual number of the terminals 10 illustrated in FIG. 1 is one example.

Each of the terminals 10, the relay apparatus 30, and the management system 50 is connected to another one of the terminals 10, the relay apparatus 30, and the management system 50 through a communications network 2. The communications network 2 may include, for example, a LAN (Local Area Network), the Internet, a mobile phone network, and a private line.

The terminals (i.e., communications terminals) 10 may be, for example, general-purpose information terminals such as tablet terminals, smartphones, or PC (Personal Computers), or communications terminals dedicated as video n conference apparatuses. A terminal 10 can carry out, for example, a video conference by transmitting image data, sound data, and so forth, to and receiving image data, sound data, and so forth, from one or more other terminals 10.

Also, in FIG. 1, the terminal 10B is connected with the moving apparatus 20 in a wireless or wired manner so that the terminal 10B can carry out communications with the moving apparatus 20. The terminal 10B can control a traveling operation of the moving apparatus 20 by executing an application program (hereinafter, simply, referred to as an application) corresponding to the communications system 1. Alternatively, the terminal 10B may be integral with the moving apparatus 20, and thus, movable with the moving apparatus 20.

Another terminal 10, for example, the terminal 10A, can carry out a video conference with the terminal 10B by using an application corresponding to the communications system 1, and also, can remotely operate the moving apparatus 20 via the terminal 10B. For example, the user of the terminal 10A can move the moving apparatus 20 on which the terminal 10B is installed, for example, forward and backward, and turn left and right, by operating operation buttons included in a video conference display screen page displayed on the terminal 10A.

The moving apparatus 20 moves “forward” or “backward”, or “turns left” or “turns right” while being controlled by the terminal 10B mounted on the moving apparatus 20 by, for example, driving a plurality of wheels. Note that, the actual appearance of the moving apparatus 20 illustrated in FIG. 1 is one example. It may be sufficient that the moving apparatus 20 is movable together with the terminal 10B according to control information from the terminal 10B mounted on the moving apparatus 20. The moving apparatus 20 is one example of an apparatus controlled by the terminal 10B.

The relay apparatus 30 is, for example, an information processing apparatus, or a system that includes one or more information processing apparatuses, and relays content data transmitted or received between terminals 10.

A management system (i.e., a communications management system) 50 is, for example, an information processing apparatus, or a system that includes one or more information processing apparatuses. The management system 50, for example, authenticates a login request from a terminal 10, manages communications states of a terminal 10, manages a destination list, and so forth, and controls a session to carry out communications between terminals 10 via the relay apparatus 30.

According to the embodiments, the management system 50 manages operation authority that is authority to operate the terminal 10B and the moving apparatus 20. For example, the management system 50 manages operation authority for the terminal 10B in such a manner as to limit the number of terminals which are allowed to operate the terminal 10B into 1 from among terminals 10 which participate in a session (for example, a video conference) in which also the terminal 10B participates.

According to the embodiments, a session is implemented as a result of the relay apparatus 30 relaying content data such as image data and sound data between terminals 10.

In the above-described configuration, the user of the terminal 10A carries out communications with the terminal 10B, and can remotely move the terminal 10B and the moving apparatus 20, for example. Thereby, the user of the terminal 10A can have a video conference, for example, while moving the terminal 10B and the moving apparatus 20 near any other user.

Also, it the user of the terminal 10A is not used to operating the moving apparatus 20, the user of the terminal 10A may, for example, ask the user of the terminal 10C who is used to operating the moving apparatus 20 to participate in a video conference, and ask the user of the terminal 10C to operate the moving apparatus 20 in the video conference.

Further, according to the embodiments, the management system 50 manages operation authority that is authority to operate the terminal 10B, and, for example, can transfer the operation authority from the terminal 10A to the terminal 10C.

Thus, according to the communications system of the embodiments, in the communications system 1 including the terminal 10B that can control the moving apparatus 20, it is possible that the user of the terminal 10A can easily request the user of the terminal 10C to operate the moving apparatus 20.

Concerning the embodiments, the communications system 1, the management system 50, and the terminals (i.e., communications terminals) 10 will now be described assuming that a video conference system is one example of the communications system, a video conference management system is one example of the communications management system, and video conference terminals are examples of the communications terminals. That is, the terminals 10 and the management system 50 are used not only in a video conference system but also in any other communications systems. For example, the communications system 1 may be a telephone system, and the terminals 10 may be mobile terminals such as IP (Internet Protocol) phones, internet phones, PCs (Personal Computers), notebook PCs, smartphones, or tablet terminals.

According to the embodiments, the term “a video conference” may be replaced with a term “a TV conference”.

### <Hardware Configuration>

### (Hardware Configuration of Terminal)

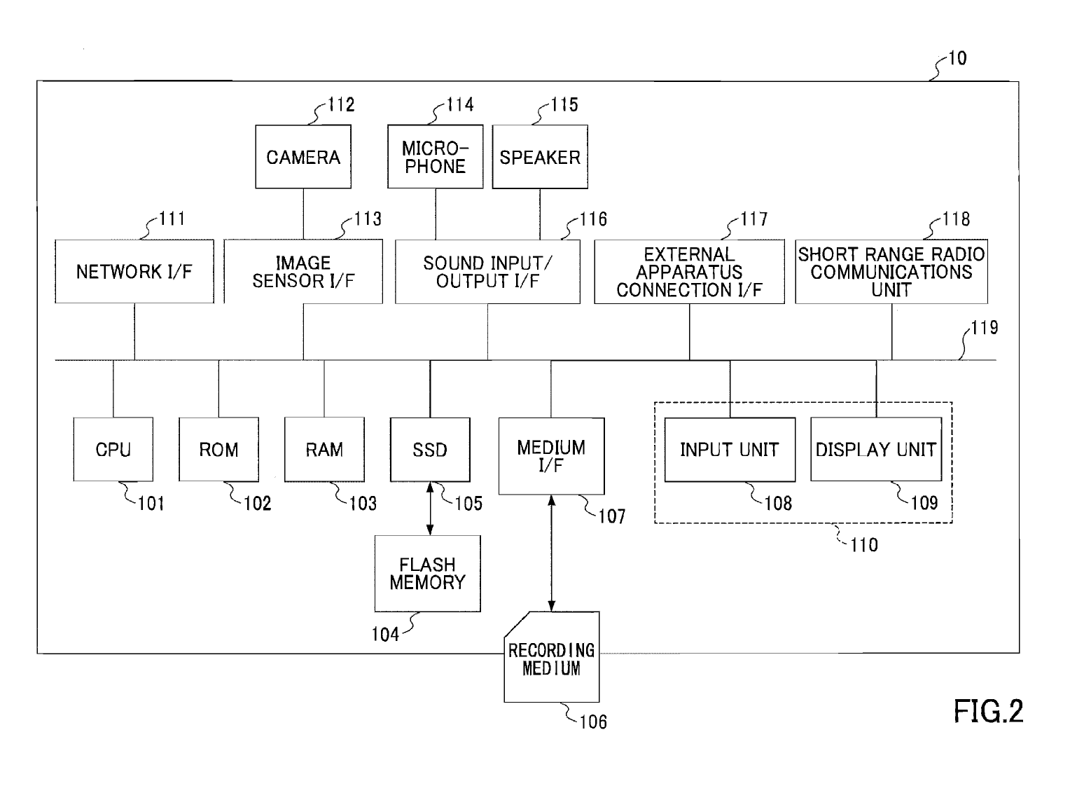

FIG. 2 illustrates a hardware configuration example of each terminal 10 according to the embodiments. The terminal 10 includes a configuration of a common computer, and includes, for example, a CPU (Central Processing Unit) 101, a ROM (Read-Only Memory) 102, a RAM (Random Access Memory) 103, a flash memory 104, and a SSD (Solid State Drive) 105. The terminal 10 also includes a medium I/F (Interface) 107, an input unit 108, a display unit 109, a network T/F 111, a camera 112, an imaging sensor I/F 113, a microphone 114, a speaker 115, and a sound input/output I/F 116. Further, the terminal 10 includes an external apparatus connection I/F 117, a short range radio communications unit 118, and a bus 119.

The CPU 101 is a processing unit that, for example, reads programs or data from the ROM 102 or the flash memory 104, and carries out processes to implement respective functions of the terminal 10. The ROM 102 is a nonvolatile memory that previously stores programs such as an IPL (Initial Program Loader) used to start the CPU 101. The RAM 103 is a volatile memory used as a work area of the CPU 101, for example.

The flash memory 104 is a storage to store, for example, an OS (Operating System), an application program, and various sorts of data. The SSD 105 controls reading various data from the flash memory 104 and writing various data to the flash memory 104 being controlled by the CPU 101. The medium I/F 107, for example, controls reading data from and writing (storing) data to (in) a recording medium 106 such as a memory card.

The input unit 108 is, for example, a touch panel, a keyboard, a pointing device, or the like, to receive the user's input operation. The display unit 109 displays various sorts of information to the user. The input unit 108 and the display unit 109 may be a display-and-input unit such as a touch panel display in which, for example, a touch panel and a display are integrated.

The network I/F 111 is a communications interface for the terminal 10 to transmit data via the communications network 2. The camera 112 includes an image sensor to image a subject being controlled by the CPU 101. The image sensor I/F 113 controls the camera 112 to take an image, and converts the taken image into image data. The microphone 114 converts collected sounds into an electric signal. The speaker 115 coverts a sound signal into sounds and outputs the sounds. The sound input/output I/F 116 controls input and output of sounds using the microphone 114 and the speaker 115.

The external apparatus connection I/F 117 is an interface, for example, for connecting to an external apparatus such as a USB (Universal Serial Bus). The external apparatus may be, for example, the moving apparatus 20 illustrated in FIG. 1.

The short range radio communications unit 118 is a communications interface for, for example, carrying out communications using short range radio communications such as Bluetooth (registered trademark) or Bluetooth Low Energy with an external apparatus (for example, the moving apparatus 20). The bus 119 is connected to the above-mentioned elements in common, and transmits address signals, data signals, and various control signals between the elements.

### (Hardware Configuration of Management System and Relay Apparatus)

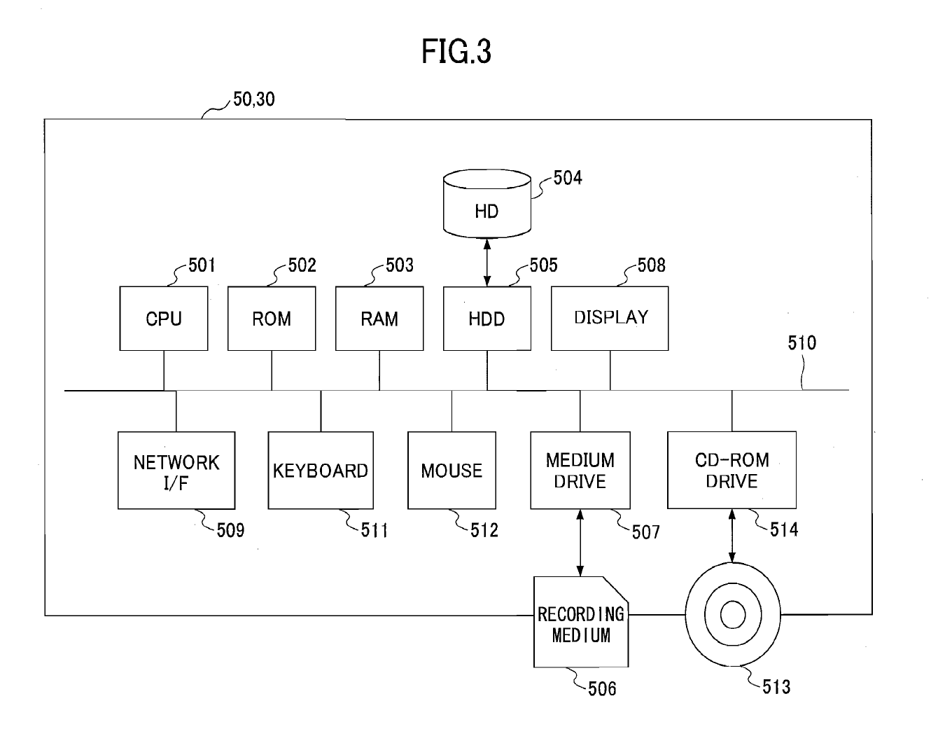

FIG. 3 illustrates a hardware configuration example of the management system and the relay apparatus according to the embodiments. The management system 50 includes a configuration of a common computer, and includes, for example, a CPU 501, a ROM 502, a RAM 503, a HD 504, a HDD (Hard Disk Drive) 505, a medium drive 507, and a display 508. Also, the management system 50 includes a network I/F 509, a keyboard 511, a mouse 512, a CD-ROM drive 514, and a bus 510.

The CPU 501 is a processing unit that, for example, reads programs or data from the ROM 502 or the HD 504, carries out processes to implement respective functions of the management system 50. The ROM 502 is a nonvolatile memory that previously stores programs such as an IPL to start the CPU 501. The RAM 503 is a volatile memory used by the CPU 501 as a work area, for example.

The HD 504 is a storage storing, for example, programs such as an OS and an application program, and various sorts of data. The HDD 505 controls, being controlled by the CPU 501, reading various sorts of data from the HD 504 and writing various sorts of data to the HD 504. The display 508 displays various sorts of information, for example, a cursor, a menu, a window, a letter, and an image.

The network I/F 509 is a communications interface for carrying out communications using the communications network 2. The keyboard 511 is one example of an input unit to receive operations of inputting letters, numerals, various instructions, and so forth. The mouse 512 is one example of a pointing device for receiving user's operations such as selecting or executing various instructions, selecting a processing object, moving a cursor, and so forth.

The medium drive 507 controls, for example, reading data from a recording medium 506 such as a memory card and writing (storing) data to the recording medium 506. The CD-ROM drive 514 controls reading data from a detachable recording medium, for example, a disk 513, and writing data to the disk 513. The bus 510 electrically connects the above-mentioned elements, and transmits address signals, data signals, and various control signals.

The above-mentioned hardware configuration of the computer is one example. For example, the display 208, the keyboard 211, the mouse 212, and so forth, may be externally connected to the management system 50.

The relay apparatus 30 has the same hardware configuration as the hardware configuration of the management system 50. Respective programs for the terminals 10, the relay apparatus 30, and the management system 50 may be circulated as a result of being recorded in computer-readable recording media in a form of files of an installable or executable format. Actual examples of the recording media include CD-R (Compact Discs Recordable), DVD (Digital Versatile Disks), Blu-ray disks, and so forth. The recording media such as CD-ROMs and the HDs 504, storing the respective programs, may be provided domestically or internationally as program products.

### (Hardware Configuration of Moving Apparatus)

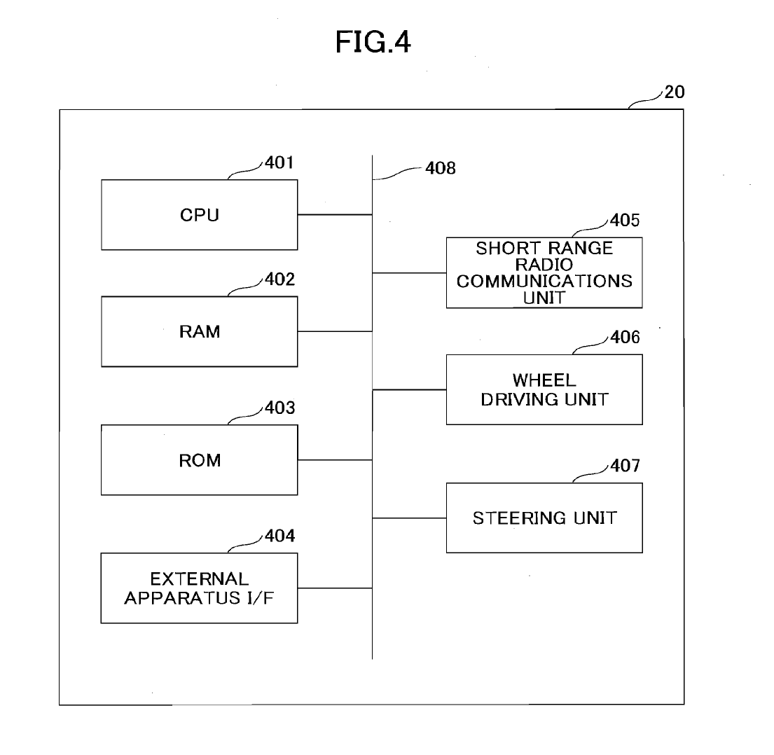

FIG. 4 illustrates a hardware configuration example of the moving apparatus according to the embodiments. The moving apparatus 20 includes, for example, a CPU 401, a RAM 402, a ROM 403, an external apparatus I/F 404, a short range radio communications unit 405, a wheel driving unit 406, and a steering unit 407.

The CPU 401 is a processing unit that executes programs stored in the ROM 403 or the like to implement respective functions of the moving apparatus 20. The RAM 402 is a volatile memory used as a work area of the CPU 401, for example. The ROM 403 is a nonvolatile memory storing the programs for the moving apparatus 20. The ROM 403 may be, for example, a rewriteable nonvolatile memory such as a flash ROM.

The external apparatus I/F 404 is a wired communications interface connected with the external apparatus connection I/F 117 of the terminal 10 illustrated in FIG. 2, or the like, in a wired manner, for carrying out communications.

The short range radio communications unit 405 is a radio communications interface for carrying out, for example, radio communications through the same radio communications system as that of the short range radio communications unit 118 the terminal 10 illustrated in FIG. 2. It is sufficient that the moving apparatus 20 is capable of carrying out communications with the terminals 10 using, for example, the external apparatus I/F 404 or the short range radio communications unit 405.

The wheel driving unit 406 is one example of a driving unit to drive wheels to move the moving apparatus 20. The wheel driving unit 406 includes, for example, a motor.

The steering unit 407 carries out a steering operation of the moving apparatus 20 that moves by the wheel driving unit 406. The steering unit 407 may have, for example, a configuration to change the directions of the wheels, or a configuration to turn the moving direction of the moving apparatus 20 by controlling the rotational speeds of the left and right wheels.

### First Embodiment

### <Function Configuration>

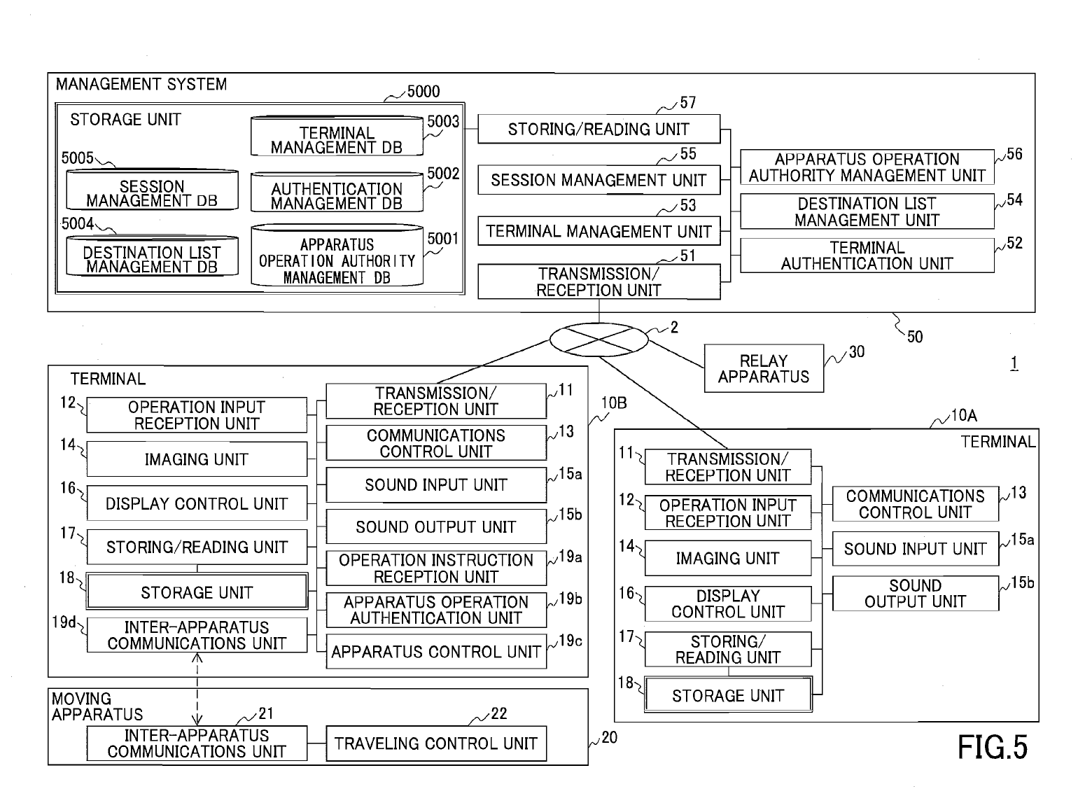

FIG. 5 illustrates a functional configuration example of the communications system according to a first embodiment.

### (Function Configuration of Terminal 10A)

The terminal 10A is one example of a terminal which, for example, does not have a function to control an apparatus such as the moving apparatus 20.

The terminal 10A includes a transmission/reception unit 11, an operation input reception unit 12, a communications control unit 13, an imaging unit 14, a sound input unit 15a, a sound output unit 15b, a display control unit 16, and a storing/reading unit 17. The respective units are functions or functional units implemented as result of some of the elements illustrated in FIG. 2 operating based on instructions from the CPU 101 according to the program for the terminal 10 written to the RAM 103 from the flash memory 104. Also, the terminal 10 has a storage unit 18 implemented by the RAM 103 and the flash memory 104 illustrated in FIG. 2.

### (Function Configuration of Terminal 10B)

The terminal 10B is one example of a terminal 10 having a function to control an apparatus such as the moving apparatus 20. The terminal 10B includes, in addition to the functional configuration described above for the terminal 10A, an operation instruction reception unit 19a, an operation instruction authentication unit 19b, an apparatus control unit 19c, and an inter-apparatus communications unit 19d.

### (Detailed Functional Configuration of Terminal 10)

Next, functional configurations of the terminals 10 (the terminal 10A and the terminal 10B) will be described in detail. Below, upon describing the functional configurations of the terminals 10, relations with elements from among the elements illustrated in FIG. 2 to implement the functional configurations of the terminal 10 will also be described.

The transmission/reception unit 11 is implemented by instructions from the CPU 101 illustrated in FIG. 2, and the network I/F 111 illustrated in FIG. 2, and transmits various sorts of data or information to and receives various sorts data or information from the terminals, the apparatus and the system via the communications network 2. Before starting conversation with a desired destination terminal, the transmission/reception unit 11 starts receiving state information of each terminal as a destination candidate from the management system 50. Note that, the state information indicates not only the operation state (“one line” or “off line”) of each terminal 10, but also a further detailed state such as, in case of “on line”, whether conversation can be performed (i.e., “communicatable” or not), whether the terminal is under conversation, or the like.

The operation input reception unit 12 is implemented by instructions from the CPU 101 illustrated in FIG. 2, and the input unit 108 illustrated in FIG. 2, and receives a user's various inputs. For example, when the user performs an operation to turn off the power in the terminal 10, the operation input reception unit 12 illustrated in FIG. 5 receives the operation, and carries out control to turn off the power.

The communications control unit 13 is implemented by instructions from the CPU 101 illustrated in FIG. 2. For example, in response to reception of an operation to turn on the power, the communications control unit 13 automatically transmits login request information to request login, and the current IP address of the requesting terminal, to the management system 50 from the transmission/reception unit 11 via the communications network 2. Also, when the user performs an operation to turn off the power in the terminal 10, the transmission/reception unit 11 transmits state information to turn off the power to the management system 50, and thereafter the operation input reception unit 12 turns the power off. Thereby, the management system 50 can determine that the power in the terminal 10 has been turned off.

Also, the communications control unit 13 carries out various sorts of communications control via the relay apparatus 30 such as establishing or disconnecting a session for transmitting content data to and receiving content data from another terminal 10. According to the first embodiment, the communications control unit 13 includes a terminal ID (Identification) of the terminal 10 in session control information (for example, start request information, start response information, or the like, described later) to be transmitted to the management system 50.

The terminal ID is one example of identification information for an account with which the user is allowed to participate in a session for transmitting content data. The terminal ID may be, for example, example, a user ID that is the user's identification information, an application ID that is identification information of an application, or a contract ID that is identification information of a contractor of the terminal 10.

The imaging unit 14 is implemented by instructions from the CPU 101 illustrated in FIG. 2, and the camera 112 and the image sensor I/F 113 illustrated in FIG. 2, converts data acquired when taking a subject into predetermined image (video) data, and outputs the image (video) data.

The sound input unit 15a is implemented by instructions from the CPU 101 illustrated in FIG. 2, and the sound input/output I/F 116 illustrated in FIG. 2, converts a sound signal acquired when a user's voice is converted by the microphone 114 into predetermined sound data, and outputs the sound data. The sound output unit 15b is implemented by instructions from the CPU 101 illustrated in FIG. 2 and the sound input/output I/F 116 illustrated in FIG. 2, converts sound data into a sound signal, and outputs sounds through the speaker

The display control unit 16 is implemented by instructions from the CPU 101 illustrated in FIG. 2, and the sound input/output I/F 116 illustrated in FIG. 2. The display control unit 16 displays image data included in content data received by the terminal 10 through the display unit 109 or the display input unit 110, for example. Also, the display control unit 16 transmits destination list information received from the management system 50 to the display unit 109, and displays the corresponding destination list through the display unit 109.

The storing/reading unit 17 is implemented by instructions from the CPU 101 illustrated in FIG. 2, and the SSD 105 illustrated in FIG. 2 or the like, or implemented by instructions from the CPU 101. The storing/reading unit 17 stores various sorts of data in the storage unit 18 and reads various sorts of data from the storage unit 18.

The storage unit 18 stores, for example, authentication information such as the terminal IDs and corresponding passwords. Also, the storage unit 18 stores various items of information (for example, operation authority and transfer authority) concerning operation authority for the terminal 10B and the moving apparatus 20 transmitted from the management system 50. The stored information in the storage unit 18 is overwritten with image data and sound data each time when the image data and sound data are received during a conversation with a destination terminal 10. From among the image data and the sound data with which the stored information in the storage unit 18 is overwritten, an image is displayed on the display unit 109 with image data before being overwritten, and a sound is output through the speaker 115 with sound data before being overwritten.

Note that, the terminal IDs and relay apparatus IDs, described later, according to the first embodiment, are examples of identification information such as languages, letters, symbols/signs, or various sorts of marks, for uniquely identifying the terminals 10 and the relay apparatuses 30. Each of the terminal IDs and relay apparatus IDs may be identification information created by combining at least two of languages, letters, symbols/signs, and various sorts of marks.

The functional configuration of the terminal 10B, other than the functional configuration described above for the terminal 10, will now be described.

The operation instruction reception unit 19a is implemented by, for example, instructions from the CPU 101 illustrated in FIG. 2, and receives operation instruction information for requesting the terminal 10B to control the apparatus (the moving apparatus 20) from another terminal 10 via the transmission/reception unit 11. The operation instruction information includes, for example, the terminal ID of the terminal 10 that transmits the operation instruction information, and control information that indicates the actual contents of the control requested.

The operation instruction authentication unit 19b is implemented by, for example, instructions from the CPU 101 illustrated in FIG. 2, and tries to authenticate operation instruction information received by the operation instruction reception unit 19a by determining whether the operation instruction information is information from the terminal 10 which has operation authority for the terminal 10B. For example, the operation instruction authentication unit 19b stores information of the terminal ID of the terminal 10 that has operation authority for the terminal 10B transmitted by the management system 50 in the storage unit 18 When the operation instruction reception unit 19a has received operation instruction information, the operation instruction authentication unit 19b compares the terminal ID included in the received operation instruction information with the terminal ID of the terminal 10 that has operation authority for the terminal 10B stored in the storage unit 18, and the authentication is successful when these terminal IDs agree with one another.

The apparatus control unit 19c is implemented by, for example, instructions from the CPU 101 illustrated in FIG. 2, and controls the moving apparatus 20 based on the control information included in the operation instruction information received by the operation instruction reception unit 19a and authenticated by the operation instruction authentication unit 19b.

The inter-apparatus communications unit 19d is implemented by, for example, instructions from the CPU 101 illustrated in FIG. 2, and the short range radio communications unit 118, or the external apparatus connection I/F 117 illustrated in FIG. 2. Concerning the first embodiment, description will now be made assuming that the inter-apparatus communications unit 19d uses the short range radio communications unit 118 to carry out communications with the moving apparatus 20.

### (Functional Configuration of Moving Apparatus)

The moving apparatus 20 includes, for example, an inter-apparatus communications unit 21, and a traveling control unit 22.

The inter-apparatus communications unit 21 is implemented by, for example, instructions from the CPU 401 illustrated in FIG. 4, and the external apparatus I/F 404, or the short range radio communications unit 405 illustrated in FIG. 4. Below, description will be made assuming that the inter-apparatus communications unit 21 uses the short range radio communications unit 405 to carry out communications with the terminal 10B.

The traveling control unit 22 is implemented by, for example, instructions from the

CPU 401 illustrated in FIG. 4. The traveling control unit 22 controls the moving apparatus 20 to move (travel) forward and backward, and turn left and right, by controlling, for example, the wheel driving unit 406 and the steering unit 407 illustrated in FIG. 4.

### (Functional Configuration of Management System)

The management system 50 includes a transmission/reception unit 51, a terminal authentication unit 52, a terminal management unit 53, a destination list management unit 54, a session management unit 55, an apparatus operation authority management unit 56, and a storing/reading unit 57. These units are functions or functional devices implemented as a result of some of the elements illustrated in FIG. 3 operating according to instructions from the CPU 201 based on the programs for the management system 50 written to the RAM 203 from the HD 204. Also, the management system 50 includes a storage unit 5000 implemented by the HD 204 illustrated in FIG. 3 or the like.

### (Detailed Functional Configuration of Management System)

Next, a detailed function configuration of the management system 50 will be described. Below, upon describing the functional configuration of the management system 50, relations with elements from among the elements illustrated in FIG. 3 to implement the functional configuration of the management system 50 will also be described.

The transmission/reception unit 51 is implemented by instructions from the CPU 201 illustrated in FIG. 3, and the network I/F 209 illustrated in FIG. 3, and transmits various sorts of data or information to and receives various sorts of data or information from the terminals 10 and the apparatuses via the communications network 2.

The terminal authentication unit 52 is implemented by instructions from the CPU 201 illustrated in FIG. 3. The terminal authentication unit 52 tries to authenticate a terminal 10 by, for example, determining whether the combination of the terminal ID and the password included in the login request information received by the transmission/reception unit 51 is included in an authentication management DB (Database) 5002.

The terminal management unit 53 is implemented by instructions from the CPU 201 illustrated in FIG. 3, associates, for each terminal ID, a destination name, the operation state, received date and time of request information or the like, and the IP address of the requesting terminal with one another, stores these items of information in a terminal management DB 5003, and manages these items of information. For example, the terminal management unit 53 changes the corresponding operation state from “online” to “off line” in the terminal management DB 5003 based on the state information indicating that the power is turned off transmitted from a terminal 10 as a result of the user turning off the power in the terminal 10. The terminal management DB 5003 will be described later.

The terminal management unit 53 searches a destination list management DB 5004 using the terminal ID of a terminal 10 that has requested login as a retrieval key to extract the terminal IDs of destination terminals that can carry out conversation with the requesting terminal. Further, the terminal management unit 53 searches the destination list management DB 5004 using the terminal ID of a requesting terminal that has requested login as a retrieval key to extract the terminal IDs of the other requesting terminals which register the terminal ID of the requesting terminal as a candidate for a destination terminal.

Further, the terminal management unit 53 searches the above-described terminal management DB 5003 using the extracted terminal IDs of candidates for destination terminals as retrieval keys to read the operation states for the respective extracted terminal IDs. Thus, the terminal management unit 53 acquires the operation states of the candidates for the destination terminals that can carry out conversation with the requesting terminal that has requested login. Also, the terminal management unit 53 searches the above-described terminal management DB 5003 using the terminal ID of the requesting terminal 10 that has requested login as a retrieval key to acquire the operation state of the requesting terminal.

The destination list management unit 54 is implemented by instructions from the CPU 201 illustrated in FIG. 3, and adds or deletes the terminal ID of the destination terminal for the terminal ID of each requesting terminal in the destination list management DB 5004. Note that, the destination list management DB 5004 will be described later.

The session management unit 55 is implemented by instructions from the CPU 201 illustrated in FIG. 3, and controls a session managed by the management system 50. The control of a session includes, for example, control to establish the session, control to cause a terminal 10 to participate in the established session, control to disconnect the session, and generation of a corresponding session ID. Also, the session management unit 55 associates the terminal ID of a requesting terminal 10 that has requested to start a session and the terminal ID of the destination terminal 10 with the session ID that is identification information of the session, stores these items of information in a session management DB 5005, and manages these items of information. Note that, the session management DB 5005 will be described later.

The apparatus operation authority management unit 56 is implemented by instructions from the CPU 201 illustrated in FIG. 3, and manages operation authority that is authority to operate a terminal 10 (which may be referred to as an apparatus control terminal, hereinafter, and, for example, is the terminal 10B) that controls an apparatus such as the moving apparatus 20, for example. For example, the apparatus operation authority management unit 56 changes a setting that a terminal 10 that is allowed to control an apparatus such as the moving apparatus 20 through communications with an apparatus control terminal (a first communications terminal, for example, the terminal 10B) is the terminal 10A (a second communications terminal) to a setting that a terminal 10 that is allowed to control the apparatus such as the moving apparatus 20 through communications with the apparatus control terminal (the first communications terminal, for example, the terminal 10B) is the terminal 10C (a third communications terminal). Note that the term “operation authority” may also be referred to as “apparatus operation authority”.

The apparatus operation authority management unit 56 may also manage transfer authority that is authority to transfer operation authority for an apparatus control terminal to another terminal 10. However, the apparatus operation authority management unit 56 need not manage transfer authority.

The apparatus operation authority management unit 56 may also manage, for example, information concerning an “apparatus operation charged terminal” (for example, the terminal ID of the apparatus operation charged terminal) which is a terminal 10 of a predetermined person in charge such as a user who manages the apparatus control terminal, or a user who i used to operating the apparatus control terminal. However, the apparatus operation authority management unit 56 need not manage the apparatus operation charged terminal.

The storing/reading unit 57 is implemented by instructions from the CPU 201 illustrated in FIG. 3 and the HDD 205, or implemented by instructions from the CPU 201, The storing/reading unit 57 stores various sorts of data in the storage unit 5000, and reads various sorts of data from the storage unit 5000.

### (Relay Apparatus)

The relay apparatus 30 relays transmission and reception of content data between a plurality of terminals 10 which participate in the same session based on the session ID that is identification information of the session. Note that, the functions of the relay apparatus 30 may be the same as the functions of a conventional relay apparatus, and therefore, detailed description of the functions of the relay apparatus 30 will be omitted. Note that, the functions of the relay apparatus 30 are implemented by, for example, instructions from the CPU 201 illustrated in FIG. 3.

### <Information Example Managed by Management System>

Respective management DBs stored in the storage unit 5000 of the management system 50 will now be described.

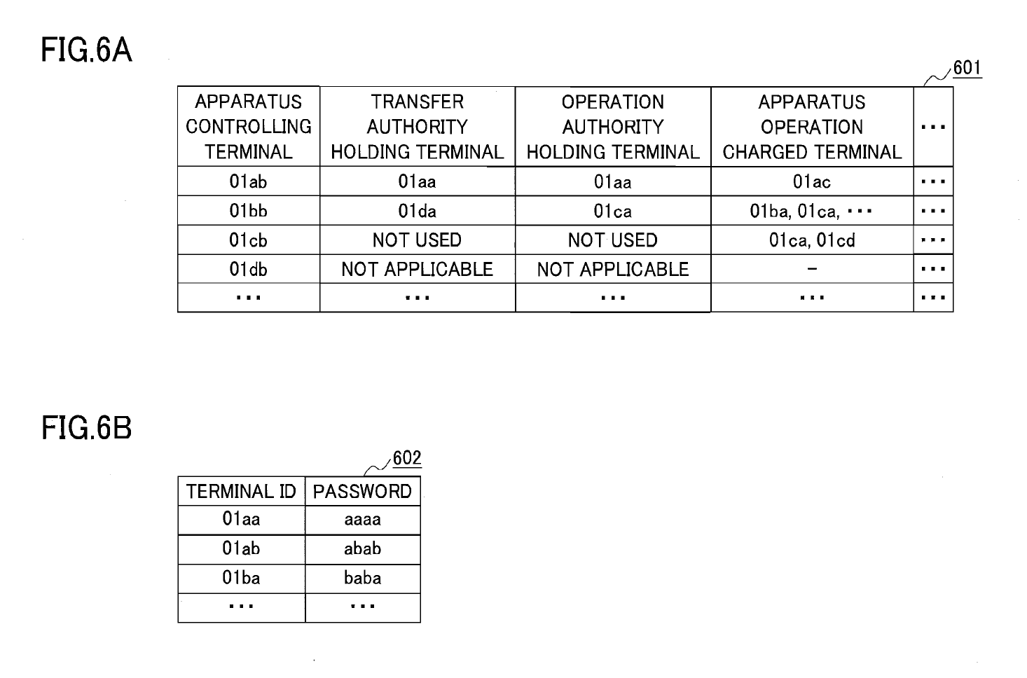

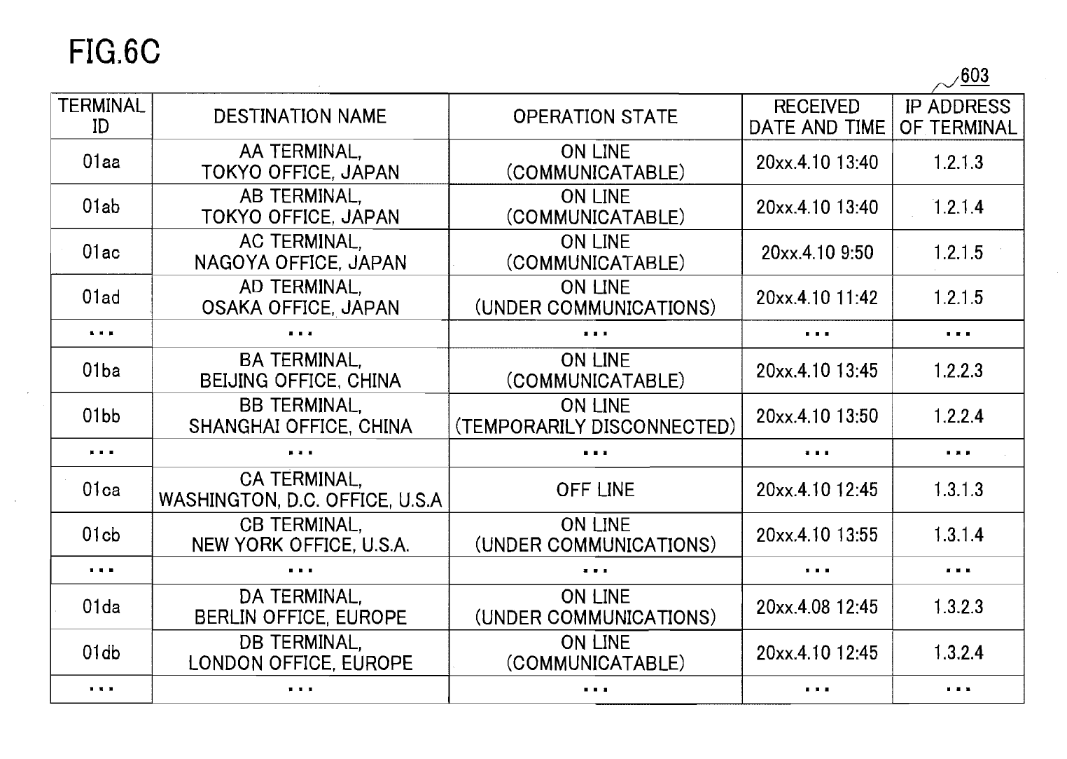

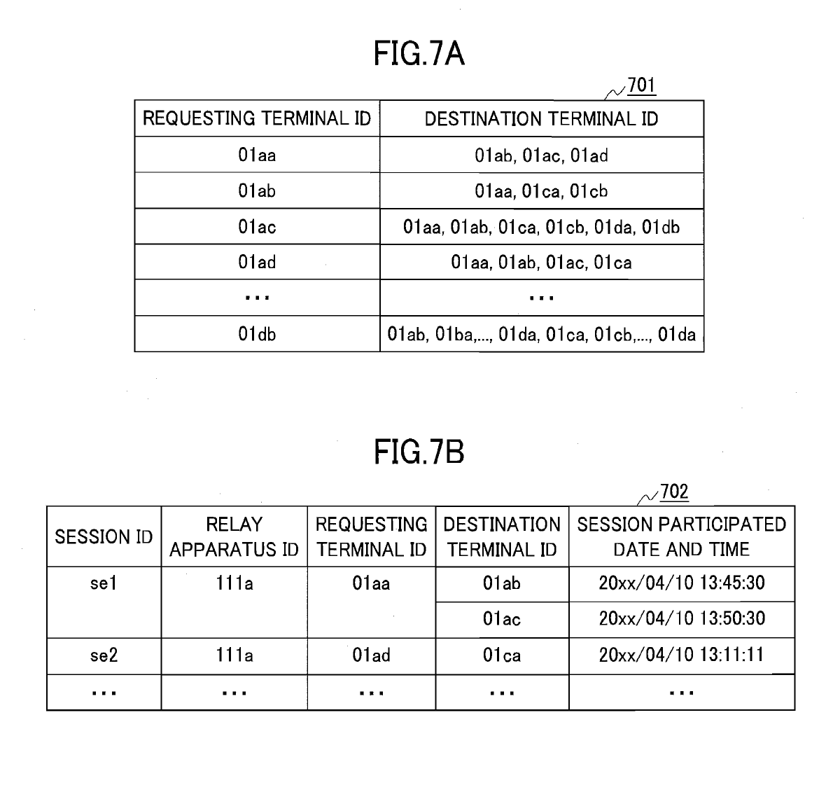

FIGS. 6A-6C, 7A and 7B illustrate examples of information managed by the management system according to the first embodiment.

### (Apparatus Operation Authority Management Table)

An apparatus operation authority management DB 5001 stored in the storage unit 5000 of the management system 50 includes, for example, an apparatus operation authority management table 601 such as the table illustrated in FIG. 6A. In the apparatus operation authority management table 601, for example, items of information such as “transfer authority holding terminal”, “operation authority holding terminal”, and “apparatus operation charged terminal” are associated with the terminal ID of the apparatus control terminal that controls an apparatus such as the moving apparatus 20, and these items of information are managed.

The item of information “transfer authority holding terminal” (for example, a terminal ID) is used to identify a terminal 10 that has authority (referred to as transfer authority) to transfer apparatus operation authority that is authority to control the apparatus control terminal. The apparatus operation authority management unit 56 stores, for example, the terminal ID of a terminal 10 that first establishes a session with the apparatus control terminal as a “transfer authority holding terminal”, and manages the stored terminal ID. Also, if apparatus operation authority has been returned from a terminal 10 to which the apparatus operation authority has been once transferred, the apparatus operation authority management unit 56 stores and manages the terminal ID of a terminal 10 that has transfer authority as an “operation authority holding terminal”. Note that, the item of information “transfer authority holding terminal” is an optional item, and need not be used.

The item of information “operation authority holding terminal” (for example, the terminal ID) is used to identify a terminal 10 that has apparatus operation authority that is authority to operate the apparatus control terminal. The apparatus operation authority management unit 56 stores and manages, for example, the terminal ID of a terminal 10 that currently has apparatus operation authority for the apparatus control terminal as an “operation authority holding terminal”.

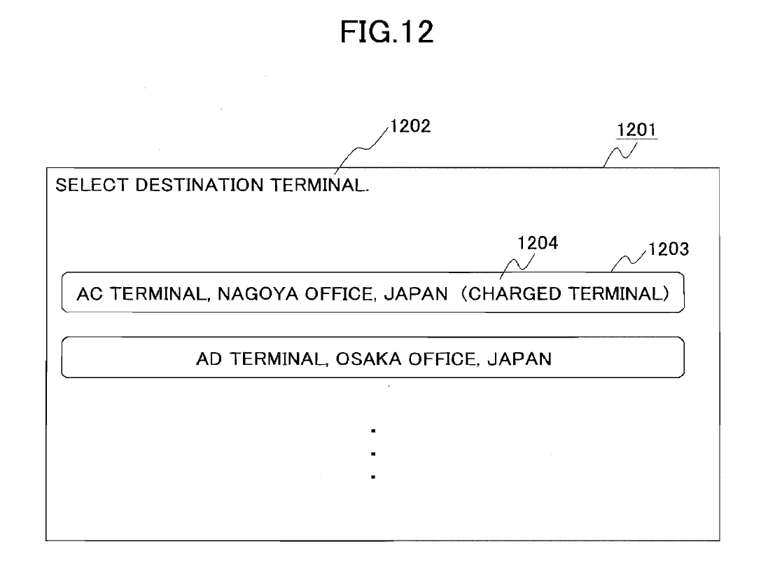

The item of information “apparatus operation charged terminal” (for example, the terminal ID) is used to identify a terminal 10 used by a predetermined person in charge of operating an apparatus such as the moving apparatus 20 such as a user who manages the apparatus control terminal or a user who is used to operating the apparatus control terminal. The item of information “apparatus operation charged terminal” includes, for example, for each apparatus control terminal, the terminal ID of the terminal of a corresponding predetermined person in charge. The item of information is used, for example, in a destination selection screen page described later with reference to FIG. 12, for making it possible to easily select a terminal 10 used by a person in charge of operating an apparatus such as the moving apparatus 20. Note that, the item of information “apparatus operation charged terminal” is an optional item of information, and need not be used.

Note that, in the apparatus operation authority management table 601 of FIG. 6A, “not used” means that the apparatus control terminal is not currently used (i.e., the apparatus control terminal has not participated in a session). In the apparatus operation authority management table 601 of FIG. 6A, “not applicable” means that the terminal is not the apparatus control terminal. The apparatus operation authority management DB 5001 and the apparatus operation authority management table 601 are examples of a function to store information of a terminal which has operation authority that is authority to operate the apparatus control terminal.

### (Authentication Management Table)

The authentication management DB 5002 stored in the storage unit 5000 of the management system 50 includes, for example, an authentication management table 602 such as the table illustrated in FIG. 6B. In the authentication management table 602, the terminal IDs of the terminals 10 managed by the management system 50 and passwords corresponding to the terminal IDs are associated with each other, and are managed. For example, in the authentication management table 602 illustrated in FIG. 6B, as can be seen, the password of the terminal 10 that has the terminal ID “01aa” is “aaaa”.

### (Terminal Management Table)

The terminal management DB 5003 stored in the storage unit 5000 of the management system 50 includes, for example, a terminal management table 603 such as the table Illustrated in FIG. 6C. In the terminal management table 603, for the terminal ID of each terminal 10, a destination name for when the terminal 10 is a destination, the operation state of the terminal 10, the received date and time at which login request information, described later, has been received by the management system 50, and the IP address of the terminal 10 are associated with each other, and are managed. For example, in the terminal management table 603 illustrated in FIG. 6C, as can be seen, the terminal 10 that has the terminal ID “01aa” has a terminal name “aa terminal, Tokyo office, Japan”, and the operation state “one line (communicatable)”. Also, concerning the terminal 10 that has the terminal ID “01aa”, the management system 50 has received login request information at “13:00, April 10, 20xx”, and the terminal 10 has the IP address “1.2.1.3”.

### (Destination List Management Table)

The destination list management DE 5004 stored in the storage unit 5000 of the management system 50 includes, for example, a destination list management table 701 such as the table illustrated in FIG. 7A. In the destination list management table 701, the terminal TDs of all the destination terminals registered as candidates for destination terminals are associated with the terminal ID of a corresponding requesting terminal which requests to start communications in a video conference, and are managed. For example, in the destination list management table 701 illustrated in FIG. 7A, candidates for destination terminals for which a requesting terminal that has the terminal ID “01ab” is allowed to request to start communications are terminals that have the terminal IDs “01aa”, “01ca”, and “01cb”. Candidates for destination terminals can be updated, as a result of the destination list management unit 54 adding or deleting a candidate for a destination terminal in response to a request of any requesting terminal to the management system 50 to add or delete the candidate for the destination terminal.

### (Session Management Table)

The session management DB 5005 stored in the storage unit 5000 of the management system 50 includes, for example, a session management table 702 such as the table illustrated in FIG. 7B. In the session management table 702, for each session ID that is identification information of a session, the relay apparatus ID of a relay apparatus 30 used to relay transmission and reception of information, the terminal ID of the requesting terminal, the terminal ID of the destination terminal, and the date and time at which the session has been started are associated with each other, and are managed. For example, in the session management table 702 illustrated in FIG. 7B, as can be seen, the session that has the session ID “se2” is carried out between the requesting terminal ID “01ad” and the destination terminal “01ca”. Also, the session that has the session ID “se2” has been started at “13:11:11, April 10, 20xx” via the relay apparatus that has the relay apparatus ID “111b”.

### <Flow of Process>

Next, a flow of a process of the communications system 1 will be described.

### (Process of Preparation Stage)

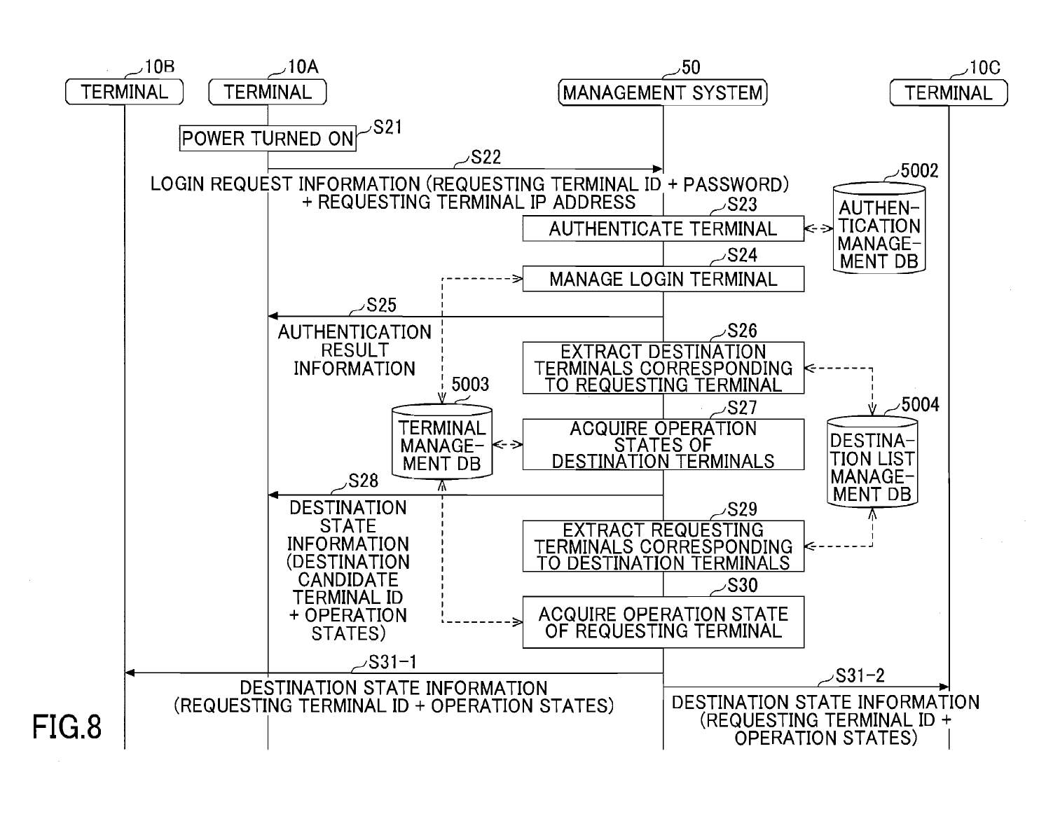

FIG. 8 is a sequence diagram illustrating a process in a preparation stage in the communications system according to the first embodiment. Below, for example, description will be made for a process in a preparation stage before the terminal 10A, the terminal 10B, and the terminal 10C start a session. Also, it is assumed that the terminal ID of the terminal 10A is “01aa”, the terminal ID of the terminal 10B is “01ab”, and the terminal ID of the terminal 10C is “01ac”. Also, it is assumed that in FIG. 8, a management information session is used to transmit and receive various items of management information.

First, when the user of the terminal 10A which is a requesting terminal has carried out, for example, an operation to turn on the power in the terminal 10A, the operation input reception unit 12 illustrated in FIG. 5 responds to the operation, and turns on the power in the terminal 10A (step S21). In response to the turning on the power, the communications control unit 13 transmits login request information to request to log in to the management system 50 via the communications network 2 from the transmission/reception unit 11 (step S22). Note that, transmission of the login request information in response to an operation of turning on the power in the terminal 10A is one example. It is also possible that login request information is transmitted in response a user's operation to the input unit 108 or to start an application, for example.

In the login request information, the terminal ID (i.e., a requesting terminal ID) and the password for identifying the terminal 10A itself. The terminal ID and the password are read from, for example, the storage unit 18 via the storing/reading unit 17. After the terminal 10A transmits the login request information to the management system 50, the management system 50 can acquire the IP address of the terminal 10A.

Next, the terminal authentication unit 52 of the management system 50 searches the authentication management table 602 using the terminal ID and the password included in the login request information received via the transmission/reception unit 51 as retrieval keys. The terminal authentication unit 52 thus carries out authentication by determining whether the combination of the terminal ID and the password included in the login request information received from the terminal 10A is included in the authentication management table 602 (step 823).

If the terminal authentication unit 52 determines in step 823 that the login request is a login request from the terminal 10A that is an authorized terminal, the terminal management unit 53 changes the operation state of the terminal ID “01aa” of the terminal 10A recorded in the terminal management table 603 into “on line (communicatable)”. At the same time, the terminal management unit 53 updates the received date and time, and also, if appropriate, updates the IP address of a terminal 10 (step S24). Thereby, in the terminal management table 603, the operation state “on line (communicatable)”, the received date and time “20XX.4.10.13:40”, and the IP address “1.2.1.3” of the terminal 10A are associated with the terminal ID “01aa” of the terminal 10A, and are managed.

Then, the transmission/reception unit 51 of the management system 50 transmits authentication result information that indicates authentication result acquired from the terminal authentication unit 52 to the terminal 10A, i.e., the requesting terminal that has requested login, via the communications network 2 (step S25). Below, a case where the terminal authentication unit 52 determines that the requesting terminal is an authorized terminal will be described.

The terminal management unit 53 of the management system 50 searches the destination list management table 701 using the terminal ID “01aa” of the requesting terminal (the terminal 10A) that has requested login, as a retrieval key. Thus, the terminal management unit 53 extracts the terminal IDs of candidates for destination terminals that can carry out communications with the requesting terminal (the terminal 10A) (step S Below, for example, it is assumed that the terminal IDs “01ab”, “01ac”, and “01ad” of destination terminals corresponding to the terminal ID “01aa” of the requesting terminal (the terminal 10A) are extracted.

Next, the terminal management unit 53 searches the terminal management table 603 using the extracted terminal IDs (“01ab”, “01ac”, and “01ad”) of candidates for destination terminals as retrieval keys. By thus reading the operation state for each of the extracted terminal ID, the terminal management unit 53 extracts the operation states for the terminal IDs (“01ab”, “01ac”, and “01ad”), respectively (step S27).

Next, the transmission/reception unit 51 transmits destination state information that includes the respective operation states for the terminal ID (“01ab”, “01ac”, and “01ad”) of candidates for destination terminals to the requesting terminal (the terminal 10A) (step S28). Thus, the requesting terminal (the terminal 10A) acquires the current operation stats for the terminal IDs (“01ab”, “01ac”, and “01ad”) of candidates for destination terminals of the requesting terminal (the terminal 10A).

Further, the terminal management unit 53 of the management system 50 searches the destination list management table 701 using the terminal ID “01aa” of the requesting terminal (the terminal 10A) that has requested login. Thus, the terminal management unit 53 extracts other requesting terminal IDs for each of which the terminal ID “01aa” of the requesting terminal (the terminal 10A) is registered as a candidate for a destination terminal (step S29). According to the destination list management table 701 illustrated in FIG. 7A, the terminal IDs of the other requesting terminals thus extracted are “01ab”, “01ac”, and “01ad”.

Next, the terminal management unit 53 of the management system 50 searches the terminal management table 603 using the terminal ID “01aa” of the requesting terminal (the terminal 10A) that has requested login as a retrieval key. Thus, the terminal management unit 53 acquires the operation state of the requesting terminal (the terminal 10A) that has requested login (step S30).

Then, the transmission/reception unit 51 extracts the terminal IDs (“01ab”, “01ac”) for which, from among the terminal IDs (“01ab”, “01ac”, and “01ad”) extracted in step S29, each of the operation states are “on line (communicatable)” in the terminal management table 603. Also, the transmission/reception unit 51 transmits destination state information that includes the terminal ID “01aa” and the operation state “on line (communicatable)” of the requesting terminal (the terminal 10A) to the terminals 10B and 10C corresponding to the extracted terminal IDs (“01ab” and “01ac”) (steps S31-1 and S31-2).

When the transmission/reception unit 51 is to transmit the destination state information to the terminals 10B and 10C, the transmission/reception unit 51 uses the IP addresses of these terminals managed in the terminal management table 603 acquired based on the respective terminal IDs (“01ab” and “01ac”). Thus, the transmission/reception unit 51 transmits the terminal ID “01aa” and the operation state “on line” of the requesting terminal (the terminal 10A) to each of the destination terminals (the terminals 10B and 10C) that can carry out communications with the requesting terminal (the terminal 10A) that has requested login as a destination.

Also each of the other terminals 10 carries out the same steps as steps S22 through S31-1 and S31-2 in response to, for example, the user's operation to turn on the power.

### (Communications Process)

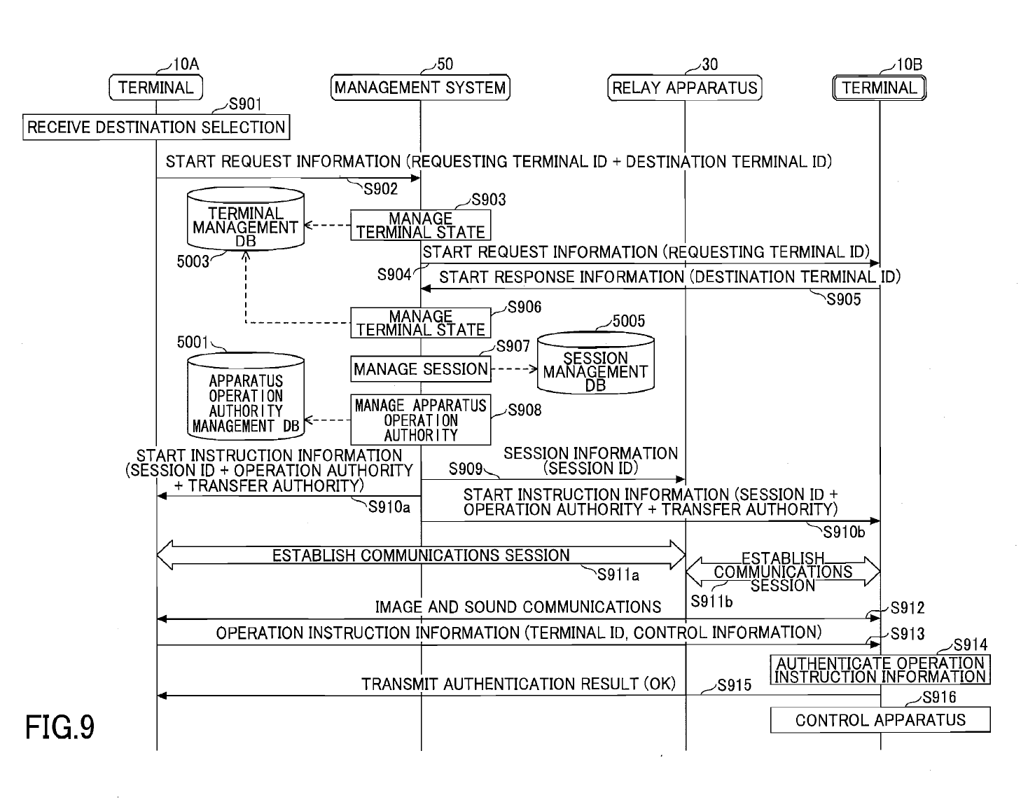

FIG. 9 is a sequence diagram illustrating an example of a communications process of the communications system 1 according to the first embodiment. Below, an example of a communications method for starting communications between the terminal 10A and the terminal 10B that is the apparatus control terminal that can control the moving apparatus 20 will be described.

In step S901, when the terminal 10A has received an operation to select a destination terminal (the terminal 105) by the user of the terminal 10A, the terminal 10A transmits start request information to the management system 50 to request to start a session (step S902). The start request information includes, for example, requesting terminal ID that is the terminal ID of the terminal 10A that is a requesting terminal, a destination terminal ID that is the terminal ID of the terminal 10B that is a destination terminal, and so forth. Further, the start request information includes information such as the IP address of the terminal 10A (i.e., a requesting terminal IP address).

In step S903, the terminal management unit 53 of the management system 50 that has received the start request information from the terminal 10A updates the terminal management DB 5003 based on the terminal ID “01aa” of the requesting terminal (the terminal 10A) included in the start request information. For example, the terminal management unit 53 changes the “operation state” corresponding to the terminal ID “01aa” of the terminal 10A into “on line (under communications)”, and also, updates the corresponding “received date and time”.

In step S904, the session management unit 55 of the management system 50 transmits start request information to the terminal 10B that is a destination terminal to request to start a session. The start request information includes, for example, the terminal ID of the terminal 10A of the requesting terminal.

In step S905, the terminal 10B that has received the start request information from the management system 50 transmits start response information to the management system 50. The start response information includes, for example, the terminal ID of the terminal 10B that is the destination terminal.

In step S906, the terminal management unit 53 of the management system 50 that has received the start response information from the terminal 10B updates the terminal management DB 5003 based on the terminal ID “01ab” of the terminal 10B included in the start response information. For example, the terminal management unit 53 changes the “operation state” corresponding to the terminal ID “01ab” of the terminal 10B into “on line (under communications)”, and also, updates the corresponding “received date and time”.

In step S907, the session management unit 55 of the management system 50 generates a session ID that is identification information for identifying the session. The session management unit 55 then associates the generated session ID with the terminal ID of the requesting terminal (the terminal ID of the terminal 10A) and the terminal ID of the destination terminal (the terminal ID of the terminal 10B), and stores the generated session ID in the session management DB 5005.

In step S908, the apparatus operation authority management unit 56 of the management system 50 stores information of the terminal 10A that is the requesting terminal as a terminal 10 that has operation authority and transfer authority for the terminal 10B that is the apparatus control terminal, in the apparatus operation authority management DB 5001. For example, the apparatus operation authority management unit 56 stores the terminal ID of the terminal 10A “01aa” as a “transfer authority holding terminal” and also, as an “operation authority holding terminal”, corresponding to the apparatus control terminal “01ab”, in the apparatus operation authority management table 601 of FIG. 6A.

In step S909, the session management unit 55 of the management system 50 transmits session information to the relay apparatus 30. The session information includes, for example, the session ID generated in step S907.

In step S910a, the session management unit 55 of the management system 50 transmits start instruction information to give an instruction to the terminal 10A to start the session. In the same way, in step S910b, the session management unit 55 of the management system 50 transmits start instruction information to give an instruction to the terminal 10B to start the session.

The start instruction information includes, for example, the session ID, and information concerning the transfer authority and the operation authority for the terminal 10B. The information concerning the transfer authority and the operation authority for the terminal 10B is, for example, information corresponding to “transfer authority holding terminal” and “operation authority holding terminal” in the apparatus operation authority management table 601 of FIG. 6A.

Through the process, the management system 50, the terminal 10A, and the terminal 10B have information concerning the operation authority and the transfer authority for the terminal 10B.

Note that, as an optional way, the start instruction information transmitted by the terminal 10A may include information corresponding to “apparatus operation charged terminal” in the apparatus operation authority management table 601 of FIG. 6A.

In step S911a, the terminal 10A establishes the communications session between the terminal 10A and the relay apparatus based on the received start instruction information. In the same way, in step S911b, the terminal 10B establishes the communications session between the terminal 10B and the relay apparatus 30 based on the received start instruction information. Thus, the terminal 10A and the terminal 10B participate in the communications session that has the same session ID, and can carry out, for example, a video conference by transmitting and receiving content data such as image data and sound data.

Also, the terminal 10A can transmit information concerning operation of an apparatus (for example, the moving apparatus 20) to and receive information concerning operation of the apparatus from the terminal 10B using the established communications session with.

Note that, it is also possible to transmit and receive the information concerning operation of the apparatus using a control session via the management system 50, or transmit and receive the information concerning operation of the apparatus between the terminal 10A and the terminal 10B using the communications network 2, or the like, without using the communications session.

Below, a case where the terminal 10A transmits to and receives from the terminal 10B the information concerning operation of the apparatus (for example, the moving apparatus 20) using the established communications session will be described.

In step S913, when the user of the terminal 10A has performed an operation from an apparatus operation screen page displayed on the terminal 10A, operation instruction information according to the operation is transmitted via the communications session. The operation instruction information includes, for example, the terminal ID of the terminal 10A, and control information according to the contents of the user's operation.

In step S914, when the operation instruction reception unit 19a of the terminal 10B has received the operation instruction information transmitted by the terminal 10A, the operation instruction authentication unit 19b tries to authenticate the received operation instruction information. For example, the operation instruction authentication unit 19b compares the terminal ID included in the operation instruction information with the terminal ID of the terminal that holds operation authority for the terminal 10B reported from the management system 50. Then, if the comparison result is that both the terminal IDs agree with each other, the operation instruction authentication unit 19b determines that the authentication is successful. The operation instruction authentication unit 19b transmits the authenticated operation instruction information to the apparatus control unit 19c.

In step S915, the operation instruction authentication unit 19b of the terminal 10B transmits the authentication result to the terminal 10A. Below, description will be made assuming that the authentication result of step S914 is OK (i.e., successful).

In step S916, the apparatus control unit 19c of the terminal 10B controls the apparatus (i.e., the moving apparatus 20) based on the control information included in the transmitted operation instruction information via the inter-apparatus communications unit 19d.

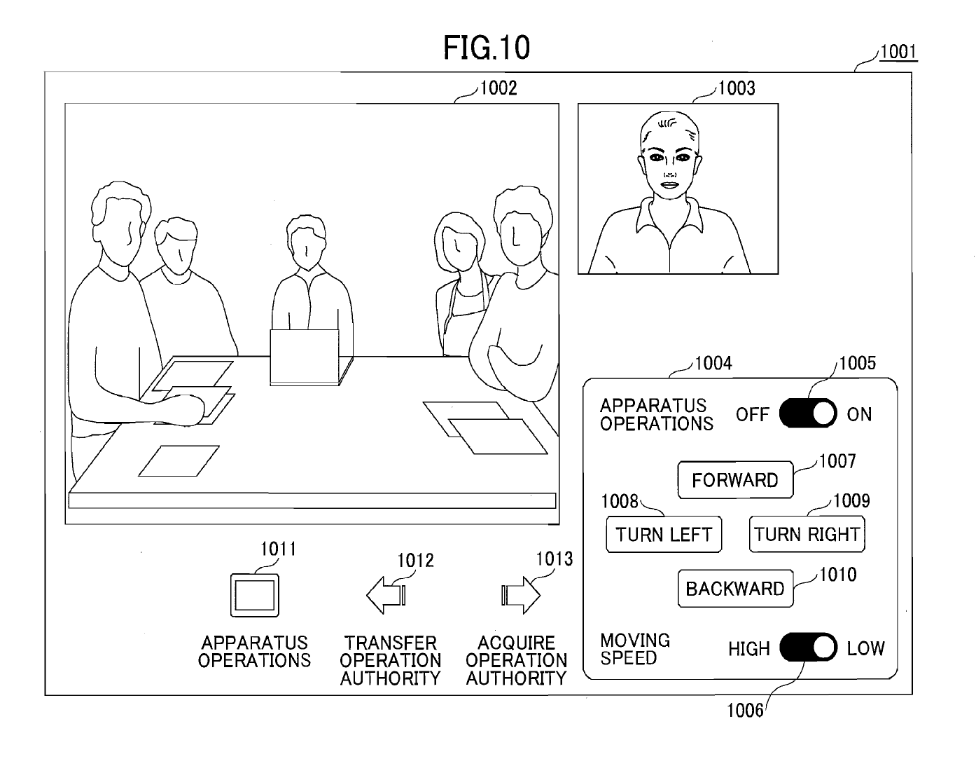

FIG. 10 illustrates an example of a display screen page of a terminal 10 according to the first embodiment. In the display screen page 1001 of the terminal 10A that is an apparatus operation terminal, an image 1002 taken by the imaging unit 14 of the terminal 10B, an image 1003 taken by the imaging unit 14 of the terminal 10A, and an apparatus operation screen page 1004, for example, are included.

The user of the terminal 10A is allowed to carry out a video conference with the user of the terminal 10B while viewing the images 1002 and 1003. Also, the user of the terminal 10A is allowed to remotely operate the moving apparatus 20 via the terminal 10B using the apparatus operation screen page 1004.

In the example of FIG. 10, the apparatus operation screen page 1004 includes a switch 1005 for turning on and off apparatus operations and a switch 1006 for switching the moving speed of the moving apparatus 20.

The user of the terminal 10A can select whether to operate the moving apparatus 20 by operating the switch 1005 for turning on and off apparatus operations. For example, the apparatus operation screen page 1004 may be displayed in response to an “apparatus operations” icon 1011 being selected, and may disappear in response to the switch 1005 being turned off.

Also, the user of the terminal 10A can switch the moving speed of the moving apparatus 20 between high and low by operating the switch 1006 for switching the moving speed of the moving apparatus 20.

Also, apparatus operation screen page 1004 includes a forward button 1007, a turn left button 1008, a turn right button 1009, and a backward button 1010.

The user of the terminal 10A can move the moving apparatus 20 “forward”, “turn left”, “turn right”, and move “backward”, by selecting the corresponding buttons.

Even if, for example, it is difficult for the user of the terminal 10A to directly view the terminal 10B and the moving apparatus 20, the user of the terminal 10A can remotely move the moving apparatus 20 and the terminal 10B based on the image 1002 taken by the imaging unit 14 of the terminal 10B.

### (Apparatus Operation Authority Transfer Process)

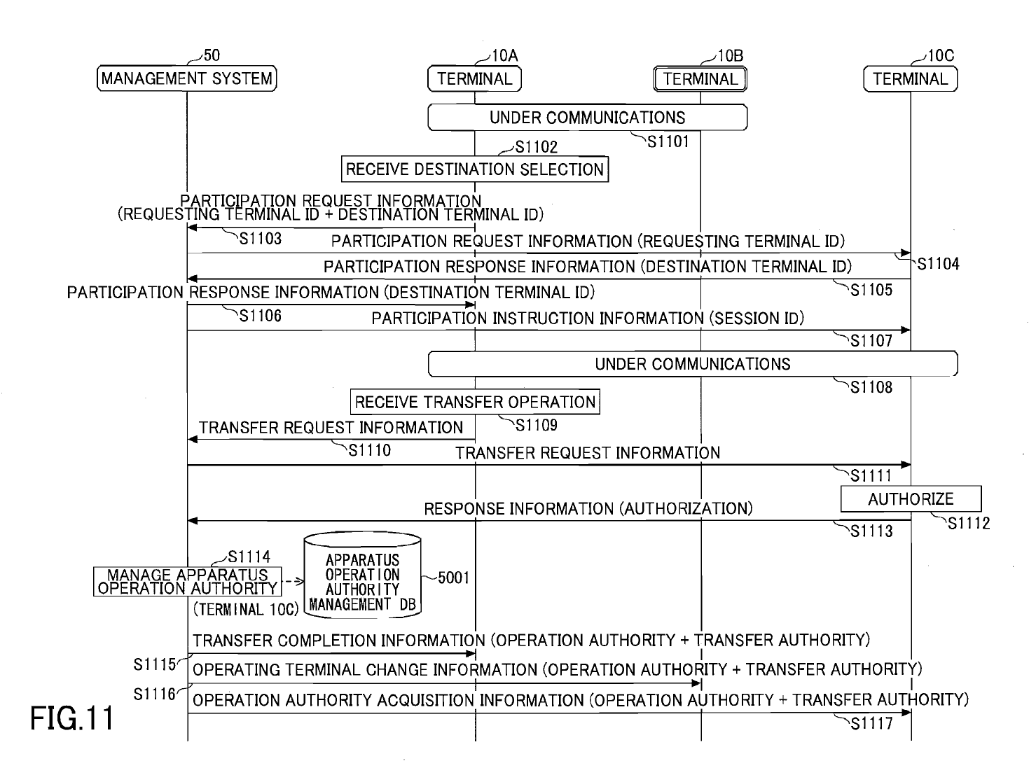

FIG. 11 is a sequence diagram illustrating an example of an apparatus operation authority transfer process according to the first embodiment. Note that, concerning the sequence diagrams of FIG. 11 and so forth, a process of terminal state management (steps S903 and S906), a process of session management (step S907), a process of the relay apparatus 30, and so forth, described above with reference to FIG. 9, will be omitted for simplifying the description.

In step S1101, it is assumed that, through the communications process of FIG. 9, the terminal 10A and the terminal 10B are under communications. However, it is assumed that the user of the terminal 10A is not used to operating the moving apparatus 20 and the terminal 10B. In such a case, according to the first embodiment, the user of the terminal 10A can request another user to operate the moving apparatus 20 and the terminal 10B through the communications system 1.

For this purpose, in step S1102, the operation input reception unit 12 of the terminal 10A receives the user's selection of a destination. FIG. 12 illustrates one example of a destination selection screen page displayed on the terminal 10A at this time.

FIG. 12 illustrates an example of the destination selection screen page of a terminal 10 according to the first embodiment. The destination selection screen page 1201 illustrated in FIG. 12 includes a message 1201 urging the user to select a destination terminal, and a plurality of buttons 1203 for selecting a destination terminal 10. The user of the terminal 10A can select a destination terminal for which participating in the session is requested by selecting one of the displayed buttons 1203, for example, for requesting the user of the destination terminal to operate the moving apparatus 20 and the terminal 10B.

For example, information 1204 that indicates that the terminal is a “charged terminal” is displayed in the button of the displayed buttons 1203 corresponding to the terminal ID of the terminal 10 stored as an “apparatus operation charged terminal” in the apparatus operation authority management table 601 of FIG. 6A.

Thereby, the user of the terminal 10A can easily select a user to whom the user of the terminal 10A requests operation of the moving apparatus 20 and the terminal 10B.

Returning to FIG. 11, the description of the sequence diagram will now be continued.

In step S1103, the communications control unit 13 of the terminal 10A transmits participation request information that requests a terminal 10 (which is assumed as the terminal 10C, for example) selected in step S1102 to participate in the session to the management system 50.

In step S1104, the session management unit 55 of the management system 50 then transmits participation request information that requests the terminal 10C to participate in the session.

In step S1105, the communications control unit 13 of the terminal 10C transmits participation response information to the management system 50.

In step S1106, the session management unit 55 of the management system 50 transmits the participation response information to the terminal 10A.

In step S1107, the session management unit 55 of the management system 50 transmits participation instruction information to give an instruction to the terminal 10C to participate in the session. The participation instruction information includes the session ID of the communications session in which the terminal 10A and the terminal 10B have participated.

In step S1108, the communications control unit 13 of the terminal 10C participates in the communications session that has been reported by the management system 50. Thereby, the terminal 10A, the terminal 10B, and the terminal 10C can carry out a video conference, or the like.

In step S1109, the terminal 10A receives the user's transfer operation. For example, the user of the terminal 10A displays the terminals 10 which have participated in the communications in a selectable manner on the terminal 10A by selecting a “transfer operation authority” icon 1012 displayed in the display screen page 1001 of the terminal 10A as illustrated in FIG. 10, and selects a terminal 10 to which the operation authority is to be transferred.

In step S1110, the terminal 10A transmits, to the management system 50, transfer request information for transferring the operation authority for the terminal 10B to the terminal 10 (that is assumed as the terminal 10C, as mentioned above) selected in step S1109.

In step S1111, the apparatus operation authority management unit 56 of the management system 50 transmits the transfer request information received from the terminal 10A to the terminal 10C.

In step S1112, the terminal 10C that has received the transfer request information receives the user's authorization operation. For example, the display control unit 16 of the terminal 10C displays an authorization button for authorizing transfer of operation authority on the display unit 109, and the operation input reception unit 12 of the terminal 10C receives the user's authorization operation. Below, description will be made assuming that the user of the terminal 10C has performed the authorization operation.

In step S1113, the communications control unit 13 of the terminal 10C transmits response information indicating to authorize transfer of the operation authority to the management system 50.

In step S1114, after receiving the response information from the terminal 10C, the apparatus operation authority management unit 56 of the management system 50 updates the information concerning operation authority for the terminal 10B in the apparatus operation authority management DB 5001. For example, the apparatus operation authority management unit 56 updates the “operation authority holding terminal” for the terminal 10B (apparatus control terminal 01ab) into the terminal ID (01ac) of the terminal 10C in the apparatus operation authority management table 601 of FIG. 6A.

In step S1115, the apparatus operation authority management unit 56 of the management system 50 transmits transfer completion information indicating that transfer of the operation authority for the terminal 10B has been completed to the terminal 10A. The transfer completion information includes, for example, information concerning the terminal IDS of the terminals 10 which have the operation authority and the transfer authority for the terminal 10B.

In step S1116, the apparatus operation authority management unit 56 of the management system 50 transmits, to the terminal 10B, operating terminal change information indicating that the terminal 10 which has the operation authority for the terminal 103 has been changed. The operating terminal change information includes, for example, information concerning the terminal IDs of the terminals 10 which have the operation authority and the transfer authority for the terminal 10B.

In step S1117, the apparatus operation authority management unit 56 of the management system 50 transmits authority acquisition information indicating having acquired the operation authority for the terminal 10B to the terminal 10C. The operation authority acquisition information includes, for example, information concerning the terminal IDs of the terminals 10 which have the operation authority and the transfer authority for the terminal 10B.

Through the process of FIG. 11, the operation authority for the terminal 10B is transferred from the terminal 10A to the terminal 10C.

(Apparatus Operating Process and Apparatus Operation Authority Return. Process)

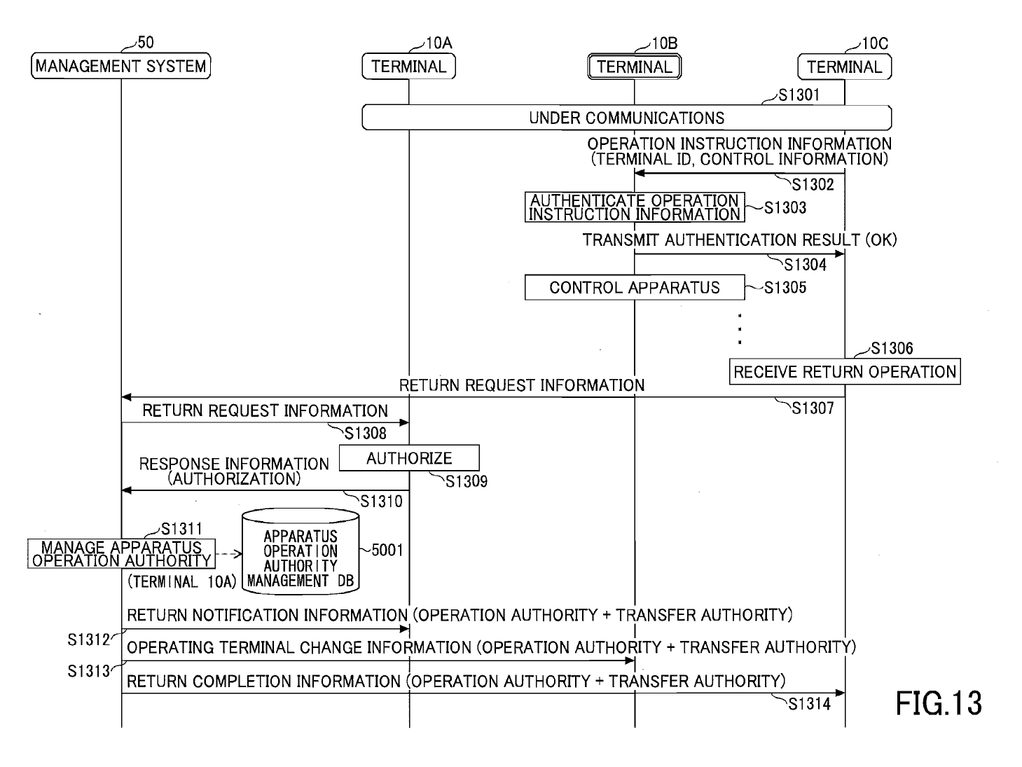

FIG. 13 is a sequence diagram illustrating an example of an apparatus operating process and an apparatus operation authority return process according to the first embodiment.

In step S1301, the terminal 10A, the terminal 10B, and the terminal 10C are under communications (for example, under a video conference), and it is assumed that the terminal 10C has operation authority for the terminal 10B through the apparatus operation authority transfer process of FIG. 11.

In step S1302, the terminal 10C transmits, to the terminal 10B, operation instruction information to request to operate the moving apparatus 20 and the terminal 10B based on an operation that has been input from the apparatus operation screen page displayed on the terminal 10C.

In step S1303, after the operation instruction reception unit 19a of the terminal 10B receives the operation instruction information transmitted from the terminal 10C, the operation instruction authentication unit 19b of the terminal 10B tries to authenticate the received operation instruction information.

In step S1304, the operation instruction authentication unit 19b of the terminal 10B transmits an authentication result to the terminal 10C. Because the terminal 10C has the operation authority for the terminal 10B, the authentication result “OK” is transmitted to the terminal 10C in step S1304.

In step S1305, the apparatus control unit 19c of the terminal 10B controls the moving apparatus 20 based on the authenticated operation instruction information.

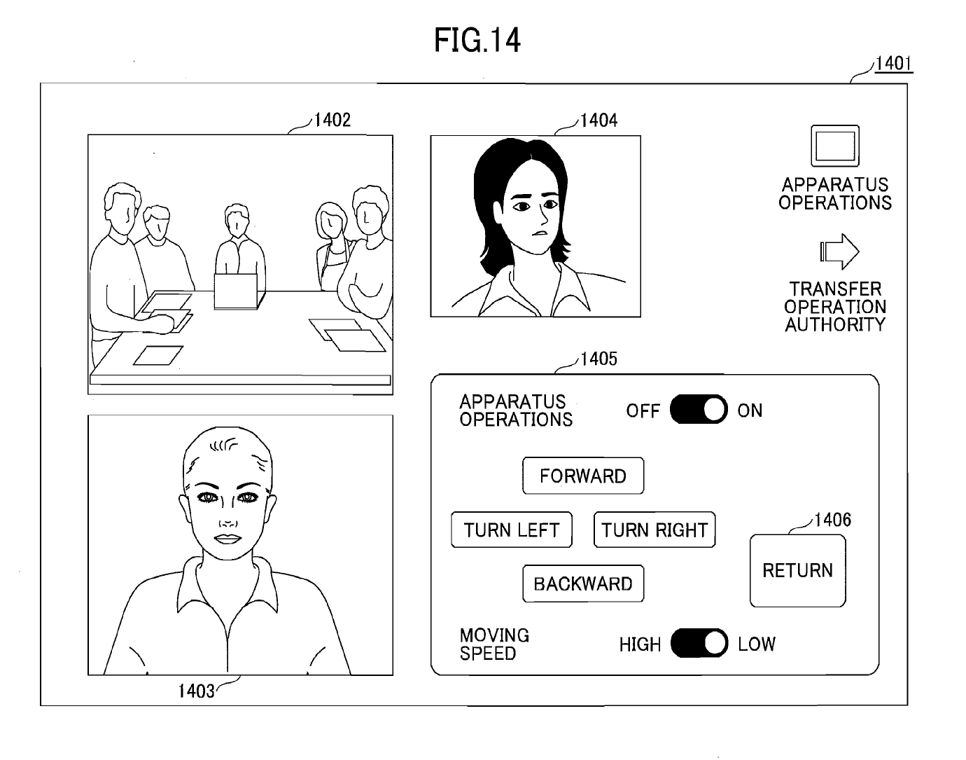

FIG. 14 illustrates an example of a display screen page of a terminal 10 to which apparatus operation authority has been transferred according to the first embodiment. For example, a display screen page 1401 displayed on the terminal 10C to which the apparatus operation authority has been transferred through the process of FIG. 11 includes, for example, an image 1402 taken by the imaging unit 14 of the terminal 10B, an image 1403 taken by the imaging unit 14 of the terminal 10A, an image 1404 taken by the imaging unit 14 of the terminal 10C, and an apparatus operation screen page 1405.

As illustrated in FIG. 14, the user of the terminal 10A can easily convey operation contents (for example, the user of the terminal 10A wishes to make a conversation with the leftmost person in the image 1402) to request the user of the terminal 10C through the video conference. That is, the image of the user of the terminal 10A is displayed on the terminal 10C as the image 1403, and thus, the user of the terminal 10A can verbally communicate with the user of the terminal 10C to convey that the user of the terminal 10A wishes to make a conversation with the leftmost person in the image 1402. As a result, the user of the terminal 10C operates the moving apparatus 20 via the terminal 10B using the apparatus operation screen page 1405 and moves the moving apparatus 20 near the leftmost person in the image 1402 together with the terminal 10B (see FIG. 1). As a result, the image of the leftmost person in the image 1402 is magnified manner in the image 1402 taken by the terminal 10B, and the user of the terminal 10A can make conversation with the corresponding person via the terminal 10B now near the person.

The apparatus operation screen page 1405 of FIG. 14 also includes a “return” button 1406, and the user of the terminal 10C can return the operation authority for the terminal 10B by selecting the “return” button 1406.

In step S1306 of FIG. 13, the operation input reception unit 12 of the terminal 10C receives the user's returning operation by, for example, detecting that the “return” button 1406 of FIG. 14 has been selected.

In step S1307, after receiving the user's returning operation in step S1306, the terminal 10C transmits return request information requesting to return the operation authority for the terminal 10B to the management system 50.

In step S1308, after receiving the return request information requesting to return the operation authority for the terminal 10B, the apparatus operation authority management unit 56 of the management system 50 reads, for example, the apparatus operation authority management table 601 illustrated in FIG. 6A, and identifies the terminal 10A which has the transfer authority for the terminal 10B. The apparatus operation authority management unit 56 then transmits return request information requesting to return the operation authority for the terminal 10B to the identified terminal 10A.

In step S1309, the terminal 10A having received the return request information receives the user's authorization operation. Below, description will be made assuming that the user of the terminal 10A has carried out the authorization operation.

In step S1310, the communications control unit 13 of the terminal 10A transmits, to the management system 50, response information that indicates to authorize return of the operation authority.

In step S1311, after receiving the response information from the terminal 10A, the apparatus operation authority management unit 56 of the management system 50 updates the information concerning the operation authority for the terminal 10B in the apparatus operation authority management DB 5001. For example, the apparatus operation authority management unit 56 updates the information of the “operation authority holding terminal” for the terminal 10B (the apparatus control terminal 01ab) into the terminal ID of the terminal 10A (01aa) in the apparatus operation authority management table 601 of FIG. 6A.

In step S1312, the apparatus operation authority management unit 56 of the management system 50 transmits return completion information indicating that return of the operation authority for the terminal 10B has been completed to the terminal 10A. The return completion information includes, for example, information concerning the terminal IDs of the terminals 10 that have the operation authority and the transfer authority for the terminal 10B.

In step S1313, the apparatus operation authority management unit 56 of the management system 50 transmits, to the terminal 10B, operating terminal change information indicating that the terminal 10 that has operation authority for the terminal 10B has been changed. The terminal change information includes, for example, information concerning the terminals ID of the terminals 10 that have the operation authority and the transfer authority for the terminal 10B.

In step S1314, the apparatus operation authority management unit 56 of the management system 50 transmits, to the terminal 10C, return completion information indicating that return of the operation authority for the terminal 10B has been completed. The return completion information includes, for example, information concerning the terminals ID of the terminals 10 that have the operation authority and the transfer authority for the terminal 10B.

### (Process to End Communications)

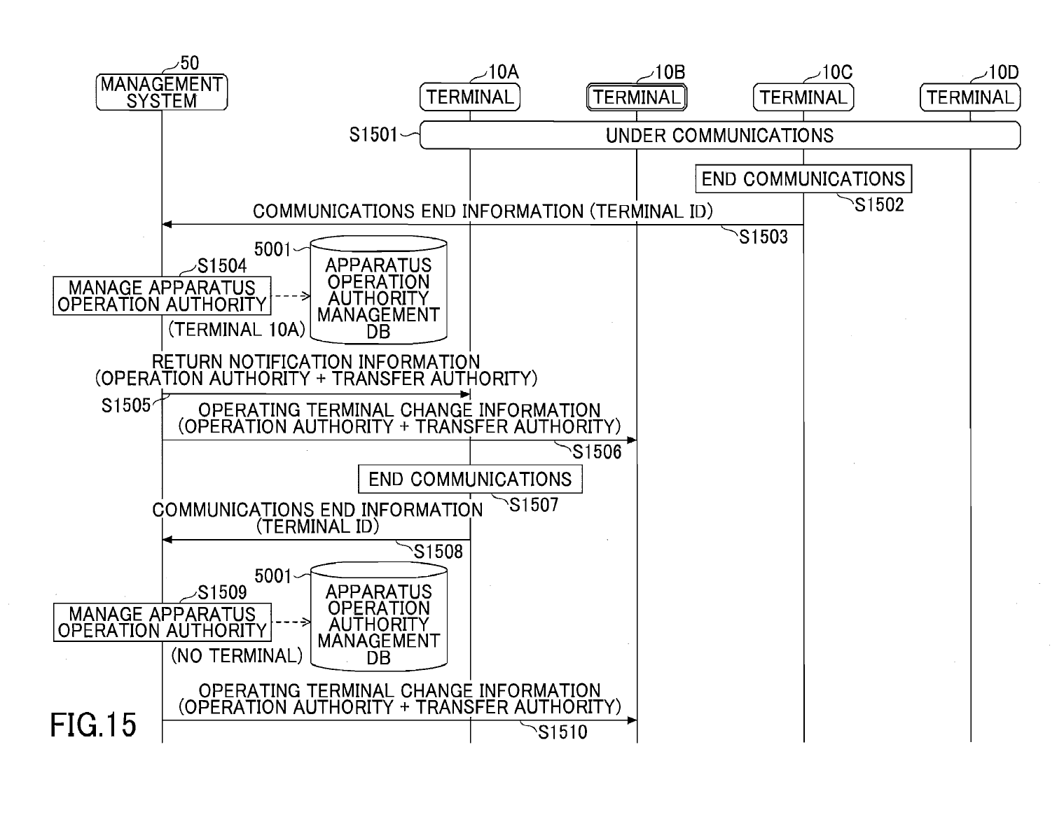

FIG. 15 is a sequence diagram illustrating an example of a process to end communications according to the first embodiment.

In step S1501, the terminal 10A, the terminal 10B, the terminal 10C, and the terminal 10D are under communications, and it is assumed that the terminal 10C has operation authority for the terminal 10B.

In step S1502, a process to end communications is carried out in the terminal 10C in response to the user's corresponding operation. Actual examples of the process to end communications include, for example, a conference leaving operation, an application ending operation, and a power turning off operation.

In step S1503, the communications control unit 13 of the terminal 10C transmits communications end information indicating to end the communications to the management system 50 before actually ending the communications.

In step S1504, after receiving the communications end information from the terminal 10C that has the apparatus operation authority for the terminal 10B, the apparatus operation authority management unit 56 of the management system 50 returns the apparatus operation authority for the terminal 10B to the transfer authority holding terminal. For example, the apparatus operation authority management unit 56 overwrites the terminal ID of “operation authority holding terminal” with the terminal ID of the “transfer authority holding terminal” (i.e., the terminal 10A, in the above-example) in the apparatus operation authority management table 601 of FIG. 6A.

In step S1505, the apparatus operation authority management unit 56 of the management system 50 transmits, to the terminal 10A, return notification information indicating that the operation authority for the terminal 10B is returned. The return notification information includes, for example, information concerning the terminal IDs of the terminals 10 that have the operation authority and the transfer authority for the terminal 10B.

In step S1506, the apparatus operation authority management unit 56 of the management system 50 transmits, to the terminal 10B, operating terminal change information indicating that the terminal 10 that has operation authority for the terminal 10B has been changed. The operating terminal change information includes, for example, information concerning the terminal IDs of the terminals 10 that have the operation authority and the transfer authority for the terminal 10B.

In step S1507, a process to end communications is carried out in the terminal 10A in response to the user's corresponding operation.

In step S1508, before actually ending the communications, the communications control unit 13 of the terminal 10A transmits communications end information indicating to end the communications to the management system 50.

In step S1509, after receiving the communications end information from the terminal 10A that has apparatus operation authority and transfer authority for the terminal 10B, the apparatus operation authority management unit 56 of the management system 50 comes to have no terminal 10 that has apparatus operation authority and transfer authority for the terminal 10B. Therefore, the apparatus operation authority management unit 56 updates the “transfer authority holding terminal” and the “operation authority holding terminal” corresponding to the terminal 10B into “not used” in the apparatus operation authority management table 601 of FIG. 6A, for example.

In step S1510, the apparatus operation authority management unit 56 of the management system 50 transmits, to the terminal 10B, operating terminal change information indicating that the terminal 10 that has operation authority for the terminal 10B has been changed. The operating terminal change information includes, for example, information indicating that there is no terminal 10 that has operation authority and transfer authority for the terminal 10B.

### (Apparatus Operation Authority Acquisition Process)

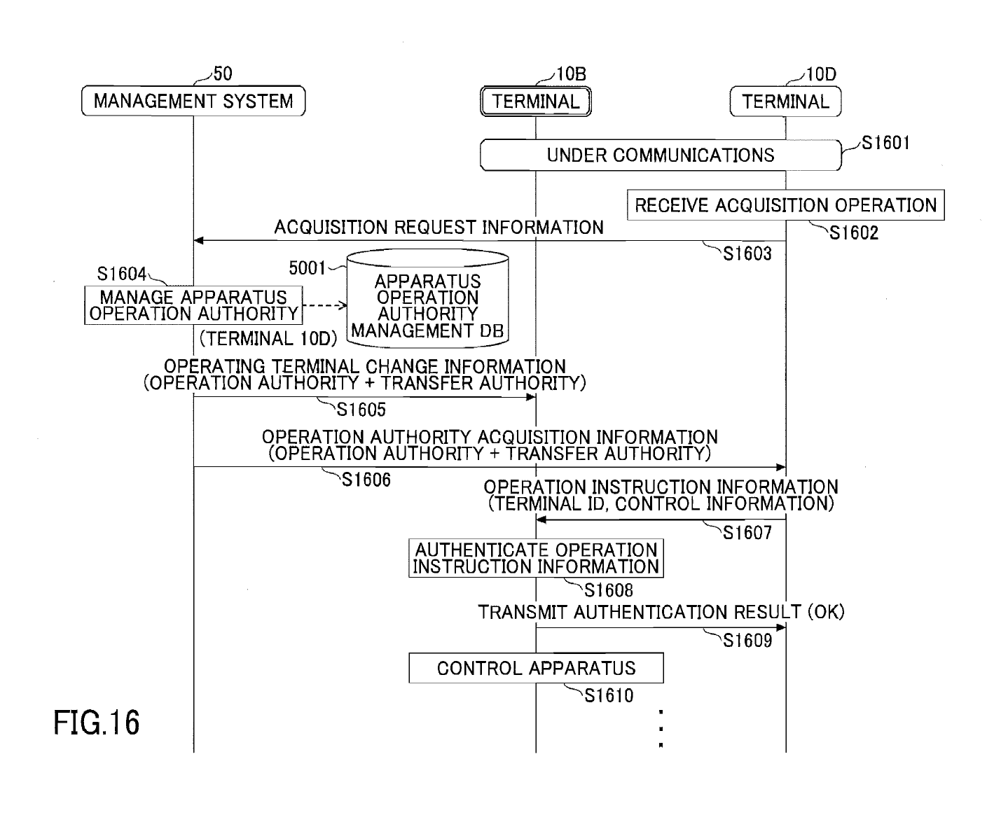

FIG. 16 is a sequence diagram illustrating an example of an apparatus operation authority acquisition process according to the first embodiment.

In step S1601, the terminal 10D is under communications with the terminal 10B, and it is assumed that there is no terminal 10 that has operation authority for the terminal 10B.

In step S1602, the terminal 10D receives the user's operation to acquire operation authority for the terminal 10B. The user of the terminal 10D performs an operation to acquire operation authority for the terminal 10B by, for example, selecting an “acquire operation authority” icon 10B displayed on the display screen page 1001 of the terminal 10D illustrated in FIG. 10.

In step S1603, the terminal 10D transmits acquisition request information requesting to acquire operation authority for the terminal 10B to the management system 50.

In step S1604, the apparatus operation authority management unit 56 of the management system 50 determines whether there is a terminal 10 that has transfer authority and operation authority for the terminal 10B by, for example, reading the apparatus operation authority management table 601 of FIG. 6A. If there is no terminal 10 that has transfer authority and operation authority for the terminal 10B, the apparatus operation authority management unit 56 stores the terminal ID of the terminal 10D as a “transfer authority holding terminal” and as an “operation authority holding terminal” corresponding to the terminal 10B in the apparatus operation authority management table 601.

In step S1605, the apparatus operation authority management unit 56 of the management system 50 transmits, to the terminal 10B, operating terminal change information indicating that the terminal 10 that has operation authority for the terminal 10B has been changed. The operating terminal change information includes, for example, information concerning the terminal ID of the terminal that has operation authority and transfer authority for the terminal 10B.

In step S1606, the apparatus operation authority management unit 56 of the management system 50 transmits, to the terminal 10D, operation authority acquisition information that indicates having acquired operation authority for the terminal 10B. The operation authority acquisition information includes, for example, information concerning the terminal ID of the terminal that has operation authority and transfer authority for the terminal 10B.

Thus, through steps S1607-S1610, the terminal 10D comes to be able to operate the terminal 10B.

(Operation Instruction information Reception Process)

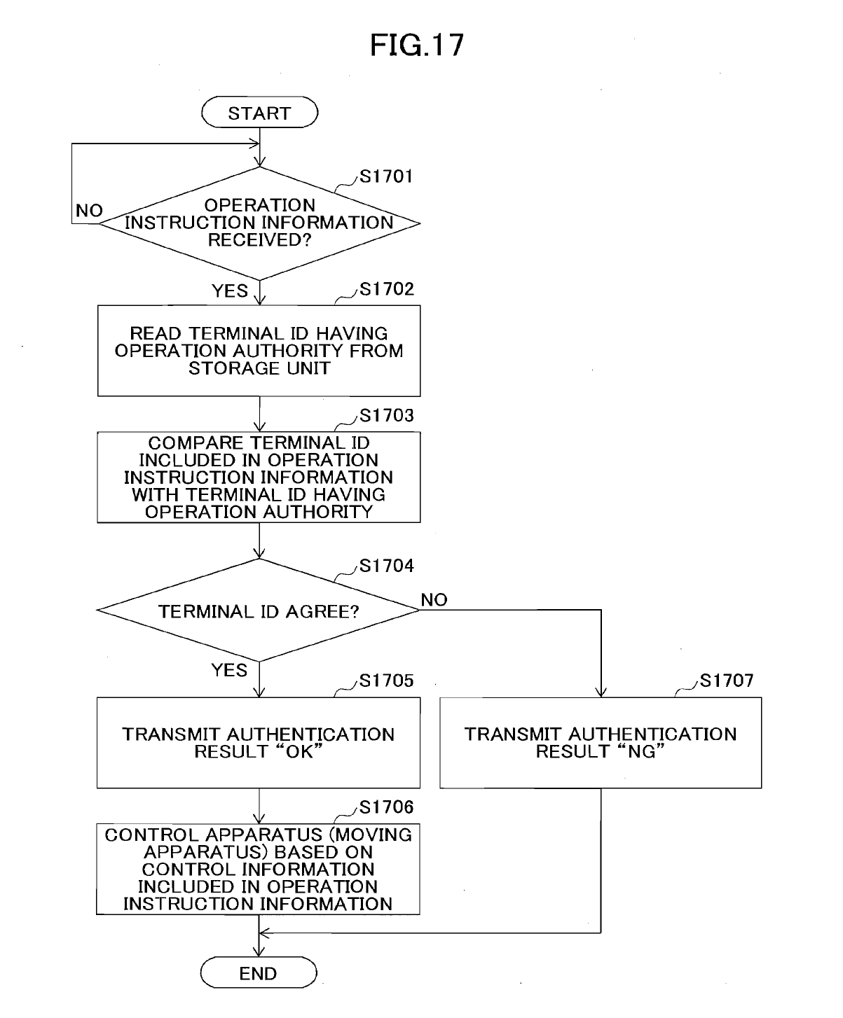

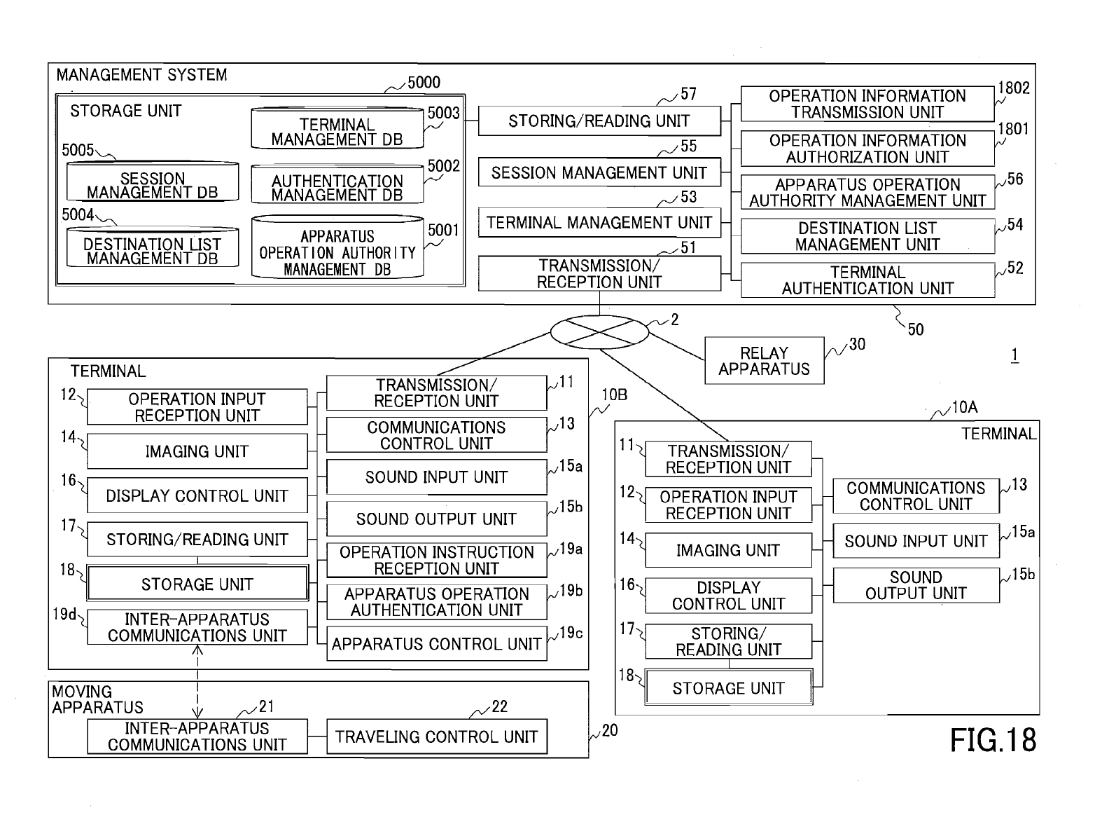

FIG. 17 is a flowchart illustrating an example of a process to receive operation instruction information according to the first embodiment. FIG. 17 illustrates one example a process carried out when the apparatus control terminal (for example, the terminal 10B) has received operation instruction information.

In step S1701, when the operation instruction reception unit 19a of the terminal 10B has received operation instruction information, the terminal 10B carries out step S1702.

In step S1702, the operation instruction authentication unit 19b of the terminal 10B reads the terminal ID of the terminal 10 that has operation authority for the terminal 10B, for example, from the storage unit 18.

In step S1703, the operation instruction authentication unit 19b of the terminal 10B compares the terminal ID included in the operation instruction information received by the operation instruction reception unit 19a with the terminal ID of the terminal 10 that has operation authority read in step 51702.

In step S1704, if the comparison result of step S1703 is that the terminal IDs agree with one another, the operation instruction authentication unit 19b carries out step S1705. If the comparison result of step S1703 is that the terminal IDs do not agree with one another, the operation instruction authentication unit 1.9b carries out step S1707.

In step S1705, the operation instruction authentication unit 19b transmits an authentication result “OK” to the terminal 10 from which the operation instruction information has been received.

In step S1706, the apparatus control unit 19c of the terminal 10B controls the apparatus (the moving apparatus 20) based on the control information included in the operation instruction information.

In step S1707, the operation instruction authentication unit 19b transmits an authentication result “NG” to the terminal 10 from which the operation instruction information has been received, and the process of FIG. 17 is ended.

### Second Embodiment

Concerning the first embodiment described above, the example where the terminal 10A that has apparatus operation authority for the terminal 10B uses a communications session via the relay apparatus 30 to transmit operation instruction information to the terminal 10B has been described.

According to a second embodiment, the terminal 10A that has apparatus operation authority for the terminal 10B transmits operation instruction information to the terminal 10B via the management system 50.

### <Functional Configuration>

FIG. 13 illustrates an example of a functional configuration of a communications system according to the second embodiment. A management system 50 shown in FIG. 13 has, in addition to the configuration of the management system 50 according to the first embodiment illustrated in FIG. 5, an operation information authentication unit 1801 and an operation information transmission unit 1302.

The operation information authentication unit 1801 tries to authenticate, for example, operation instruction information transmitted from the terminal 10A to the terminal 10B via the management system 50. For example, the operation information authentication unit 1801 compares the terminal ID included in operation instruction information received from the terminal 10A with the terminal ID as an “operation authority holding terminal” corresponding to the terminal 10B included in the apparatus operation authority management table 601 of FIG. 6A, to authenticate the operation instruction information.

The operation information transmission unit 1802 transfers operation instruction information authenticated by the operation information authentication unit 1801 to a terminal 10 that is a destination. For example, if authentication of operation instruction information transmitted from the terminal 10A for the terminal 10B via the management system 50 is successful, the operation information transmission unit 1802 actually transfers the operation instruction information to the terminal 10B.

Note that, except for the operation information authentication unit 1801 and the operation information transmission unit 1802, the configuration of the second embodiment may be the same as the configuration of the communications system 1 according to the first embodiment illustrated in FIG. 5.

### <Flow of Process>

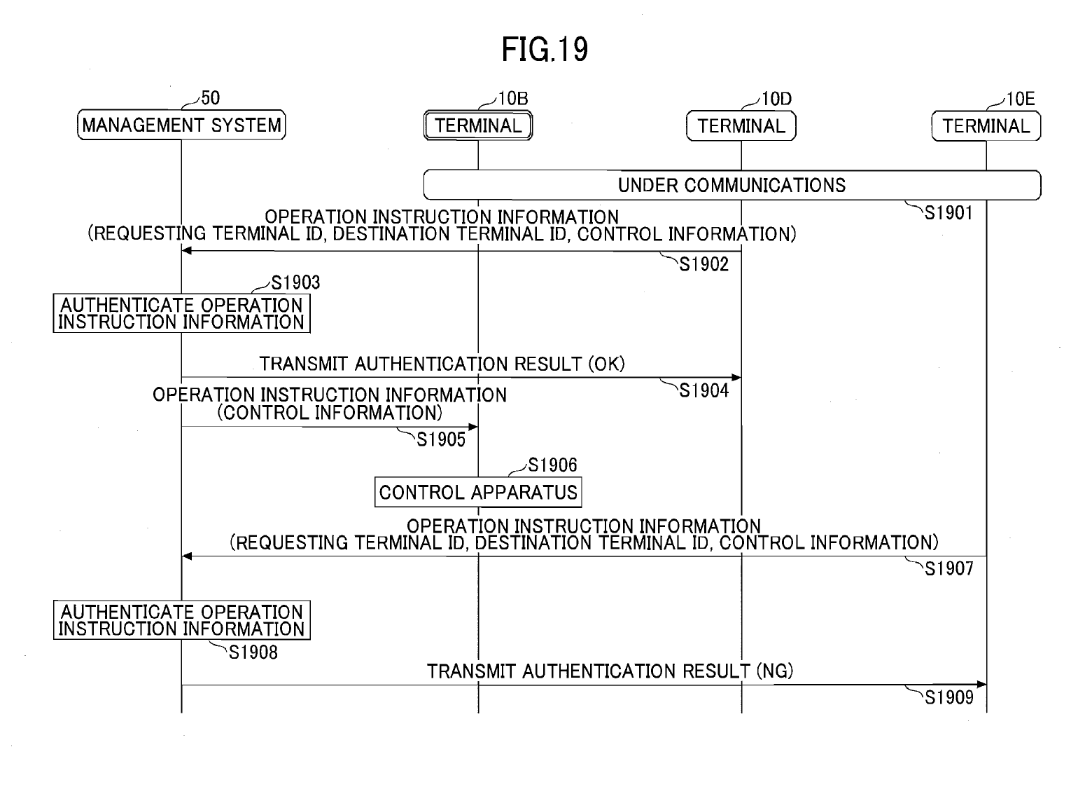

FIG. 19 is a sequence diagram illustrating a process to operate an apparatus (such as the moving apparatus 20) according to the second embodiment.

In step S1901, the terminal 10B, the terminal 10D, and the terminal 10E are under communications, and it is assumed that the terminal 10D has apparatus operation authority for the terminal 10B.

In step S1902, the terminal 10D that has operation authority for the terminal 10B transmits operation instruction information to give an instruction to operate the terminal 10B and the moving apparatus 20 to the management system 50. The operation instruction information includes, for example, the terminal ID of the requesting terminal 10D, the terminal ID of the destination terminal 10B, and control information.

In step S1903, the operation information authentication unit 1801 of the management system 50 tries to authenticate the operation instruction information received from the terminal 10D. Because the terminal 10D has apparatus operation authority for the terminal 10E, the authentication is successful.

In step S1904, the operation information authentication unit 1801 of the management system 50 transmits the authentication result (OK) to the terminal 10D.

In step S1905, the operation information transmission unit 1802 of the management system 50 transmits the operation instruction information authenticated in step S1903 to the terminal 10B.

In step S1906, the apparatus control unit 19c of the terminal 10B controls the moving apparatus 20 based on the control information included in the operation instruction information received by the operation instruction reception unit 19a of the terminal 10B.

In step S1907, the terminal 10E that has no operation authority for the terminal 10B transmits operation instruction information to give an instruction to operate the terminal 10B and the moving apparatus 20 to the management system 50. The operation instruction information includes, for example, the terminal ID of the requesting terminal 10E, the terminal ID of the destination terminal 10B, and control information.

In step S1908, the operation information authentication unit 1801 of the management system 50 tries to authenticate the operation instruction information received from the terminal 10E. Because the terminal 10E has no apparatus operation authority for the terminal 10B, the authentication fails.

In step S1909, the operation information authentication unit 1801 of the management system 50 transmits the authentication result (MG) to the terminal 10E.

Thus, a process to authenticate operation instruction information for operating the terminal 10B and the moving apparatus 20 can be carried out also by the management system 50. Further, even when a process to authenticate operation instruction information is carried out by the management system 50, also terminal 10 may authenticate operation instruction information.

### Other Embodiment

Concerning the above-described embodiments, the descriptions have been made assuming that the apparatus control terminal (the terminal 10B) controls the moving apparatus 20. However, it is also possible that a predetermined apparatus controlled by the apparatus control terminal is an apparatus having no function to move.

For example, the apparatus control terminal (the terminal 10B) may have a function to control a projector (one example of an apparatus to be controlled by the apparatus control terminal), and may project an image through the projector. In this case, the projected image may have a trapezoidal distortion, for example.

In such a case, the user of the terminal 10A who is not used to operating the projector, may transfer operation authority for the terminal 10B to the terminal 10C through a process such as the process described above with reference to FIG. 11, for example, and request the user of the terminal 10C to operate the projector to correct the trapezoidal distortion of the image projected by the projector, for example. The user of the terminal C may correct the trapezoidal distortion by remotely controlling the projector via the terminal 10B by, for example, viewing an image taken by the imaging unit 14 of terminal 10B.

According to the present disclosure, it is possible to provide a communications management system with which it is possible to make it easier for a user to ask another user to operate a predetermined apparatus.

Thus, the communications management systems, the communications systems, the non-transitory recording media, and the communications management methods have been described in the embodiments. However, embodiments are not limited to the above-described embodiments, and various modifications and replacements may be made.

What is claimed is:

1. A communications management system comprising:
at least one processor configured to
manage a session for carrying out transmission and reception of content data between a first communications terminal configured to control a predetermined apparatus, a second communications terminal, and a third communications terminal; and
change a setting that a communications terminal allowed to operate the predetermined apparatus through communications with the first communications terminal is the second communications terminal to a setting that a communications terminal allowed to operate the predetermined apparatus through communications with the first communications terminal is the third communications terminal.

2. The communications management system according to claim 1, wherein
the at least one processor is further configured to
carry out a setting that the number of communications terminals allowed to operate the predetermined apparatus from among a plurality of communications terminals participating in the session is one or less.

3. The communications management system according to claim 1, wherein
the at least one processor is further configured to
after the third communications terminal ends an operation of the predetermined apparatus, change a setting that a communications terminal allowed to operate the predetermined apparatus is the third communications terminal to a setting that a communications terminal allowed to operate the predetermined apparatus is the second communications terminal.

4. The communications management system according to claim 1, wherein
the at least one processor is further configured to
transmit information of a communications terminal of a person in charge corresponding to the first communications terminal to the second communications terminal.

5. The communications management system according to claim 1, wherein
the predetermined apparatus is a moving apparatus configured to move while being controlled by the first communications terminal.

6. The communications management system according to claim 1, wherein
the session is communications for transmitting and receiving at least image data and sound data.

7. The communications management system according to claim 1, wherein
the at least one processor is further configured to
authenticate operation information that is given to the first communications terminal to operate the predetermined apparatus; and
transmit the operation information that has been authenticated to the first communications terminal.

8. A communications system comprising:
the communications management system according to claim 1; and
the first communications terminal configured to control the predetermined apparatus,
wherein
the first communications terminal comprises at least one processor configured to
receive request information requesting to control the predetermined apparatus;
authenticate the received request information; and
control the predetermined apparatus based on the authenticated request information.

9. A non-transitory recording medium that stores a program which, when executed by at least one processor, causes the at least one processor to carry out a process, the process comprising:
managing a session for carrying out transmission and reception of content data between a first communications terminal configured to control a predetermined apparatus, a second communications terminal, and a third communications terminal; and
changing a setting that a communications terminal allowed to operate the predetermined apparatus through communications with the first communications terminal is the second communications terminal to a setting that a communications terminal allowed to operate the predetermined apparatus through communications with the first communications terminal is the third communications terminal.

10. A communications management method that is carried out by a communications management system, the method comprising:
managing, by at least one processor, a session for carrying out transmission and reception of content data between a first communications terminal configured to control a predetermined apparatus, a second communications terminal, and a third communications terminal; and
changing, by at least one processor, a setting that a communications terminal allowed to operate the predetermined apparatus through communications with the first communications terminal is the second communications terminal to a setting that a communications terminal allowed to operate the predetermined apparatus through communications with the first communications terminal is the third communications terminal.
